(19) United States
(12) Patent Application Publication
(10) Pub. No.: US 2026/0303792 A1
(43) Pub. Date: Oct. 1, 2026

(54) METHODS FOR SUBBLOCK TRANSFORM FOR INTRA PREDICTION

(71) Applicant: Alibaba (China) Co., Ltd., Hangzhou (CN)

(72) Inventors: Xinwei LI, Beijing (CN); Ru-ling LIAO, Sunnyvale, CA (US); Jie CHEN, Beijing (CN); Yan YE, San Diego, CA (US)

(21) Appl. No.: 19/562,674

(22) Filed: Mar. 10, 2026

Related U.S. Application Data
(60) Provisional application No. 63/779,638, filed on Mar. 28, 2025.

(51) Int. Cl. H04N 19/11; H04N 19/184; H04N 19/186

(52) U.S. Cl. CPC H04N 19/11; H04N 19/184; H04N 19/186

(57) ABSTRACT

The present disclosure provides a computer-implemented method for video processing. The method includes receiving a bitstream; and decoding the bitstream to form/generate/output a video sequence. The decoding includes decoding a flag indicating whether a subblock transform (SBT) intra mode is applied for a current coding unit (CU), wherein the current CU is coded in an intra prediction mode; in response to the flag indicating the SBT intra mode is applied, determining a sub-mode of the SBT intra mode; and decoding residuals of a sub-block based on the sub-mode.

### CROSS-REFERENCE TO RELATED APPLICATIONS

This disclosure claims the benefits of priority to U.S. Provisional Application No. 63/779,638, filed on Mar. 28, 2025, which is incorporated herein by reference in its entirety.

### TECHNICAL FIELD

The present disclosure generally relates to video processing, and more particularly, to methods for subblock transformation for intra prediction.

### BACKGROUND

A video is a set of static pictures (or “frames”) capturing the visual information. To reduce the storage memory and the transmission bandwidth, a video can be compressed before storage or transmission and decompressed before display. The compression process is usually referred to as encoding and the decompression process is usually referred to as decoding. There are various video coding formats which use standardized video coding technologies, most commonly based on prediction, transformation, quantization, entropy coding and in-loop filtering. The video coding standards, such as the High Efficiency Video Coding (HEVC/H.265) standard, the Versatile Video Coding (VVC/H.266) standard, and AVS standards, specifying the specific video coding formats, are developed by standardization organizations. With more and more advanced video coding technologies being adopted in the video standards, the coding efficiency of the new video coding standards get higher and higher.

### SUMMARY OF THE DISCLOSURE

Embodiments of the present disclosure provide a method for decoding a bitstream. The method includes receiving a bitstream; and decoding the bitstream to form/generate/output a video sequence. The decoding includes decoding a flag indicating whether a subblock transform (SBT) intra mode is applied for a current coding unit (CU), wherein the current CU is coded in an intra prediction mode; in response to the flag indicating the SBT intra mode is applied, determining a sub-mode of the SBT intra mode; and decoding residuals of a sub-block based on the sub-mode.

Embodiments of the present disclosure provide a method for encoding a video sequence. The method includes receiving a video sequence; and encoding the video sequence by encoding a flag indicating whether a subblock transform (SBT) intra mode is applied for a current coding unit (CU), wherein the current CU is coded in an intra prediction mode; in response to the flag indicating the SBT intra mode is applied, determining a sub-mode of the SBT intra mode; and encoding residuals of a sub-block based on the sub-mode.

Embodiments of the present disclosure provide a method for transmitting a bitstream. The method includes receiving a video sequence; encoding the video sequence by encoding a flag indicating whether a subblock transform (SBT) intra mode is applied for a current coding unit (CU), wherein the current CU is coded in an intra prediction mode; in response to the flag indicating the SBT intra mode is applied, determining a sub-mode of the SBT intra mode; and encoding residuals of a sub-block based on the sub-mode.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic diagram illustrating structures of an exemplary video sequence, according to some embodiments of the present disclosure.

FIG. 2A is a schematic diagram illustrating an exemplary encoding process of a hybrid video coding system, consistent with embodiments of the disclosure.

FIG. 2B is a schematic diagram illustrating another exemplary encoding process of a hybrid video coding system, consistent with embodiments of the disclosure.

FIG. 3A is a schematic diagram illustrating an exemplary decoding process of a hybrid video coding system, consistent with embodiments of the disclosure.

FIG. 3B is a schematic diagram illustrating another exemplary decoding process of a hybrid video coding system, consistent with embodiments of the disclosure.

FIG. 4 is a block diagram of an exemplary apparatus for encoding or decoding a video, according to some embodiments of the present disclosure.

FIG. 5 illustrates exemplary reference samples used in planar mode, according to some embodiments of the present disclosure.

FIG. 6 is a schematic diagram illustrating 67 intra prediction modes, according to some embodiments of the present disclosure.

FIG. 7 illustrates adjacent blocks (L, A, BL, AR, AL) used in the derivation of a general most probable mode (MPM) list, according to some embodiments of the present disclosure

FIG. 8 illustrates an exemplary L shaped neighborhood for a given predicted block, according to some embodiments of the present disclosure.

FIG. 9 illustrates an example of four reference lines neighboring to a prediction block, according to some embodiments of the present disclosure.

FIG. 10 illustrates an exemplary extended Multiple Reference Line (MRL) candidate list, according to some embodiments of the present disclosure

FIG. 11A illustrates an examples of sub-partition depending on the block size, according to some embodiments of the present disclosure.

FIG. 11B illustrates other examples of sub-partition depending on the block size, according to some embodiments of the present disclosure.

FIG. 12 illustrates an exemplary matrix weighted intra prediction process, according to some embodiments of the present disclosure.

FIG. 13 illustrates exemplary samples used for calculating the gradients, according to some embodiments of the present disclosure.

FIG. 14 illustrates exemplary spatial Geometric Partition Mode (GPM) candidates, according to some embodiments of the present disclosure.

FIG. 15 illustrates N reference samples to predict a given W×H luma CB, according to some embodiments of the present disclosure.

FIG. 16 illustrates an exemplary example of matrix multiplications and LeakyReLUs, according to some embodiments of the present disclosure.

FIG. 17 illustrates another exemplary example of matrix multiplications and LeakyReLUs, according to some embodiments of the present disclosure.

FIG. 18 illustrates another exemplary example of matrix multiplications and LeakyReLUs, according to some embodiments of the present disclosure.

FIG. 19 illustrates an exemplary low-frequency non-separable transform (LFNST) process, according to some embodiments of the present disclosure.

FIG. 20 illustrates exemplary Region-Of-Interest (ROI) for LFNST16, according to some embodiments of the present disclosure.

FIG. 21 illustrates exemplary ROI for LFNST8, according to some embodiments of the present disclosure.

FIG. 22 illustrates exemplary process of using Matrix-based intra prediction (MIP) prediction samples to build Histogram of Gradients (HoGs), according to some embodiment of the present disclosure.

FIG. 23 illustrates an overview of proposed non-separable primary transforms (NSPTs) among existing LFNSTs, according to some embodiments of the present disclosure.

FIG. 24 illustrates exemplary subblock transform (SBT) positions, types, and transform types, according to some embodiments of the present disclosure

FIG. 25 illustrates corner subblocks (only top left is shown), according to some embodiments of the present disclosure.

FIG. 26 illustrates general principle at encoder side for advanced SBT, according to some embodiments of the present disclosure.

FIG. 27 is a flowchart of an exemplary method of a SBT intra mode, according to some embodiments of the present disclosure.

FIG. 28 illustrates exemplary modes for SBT intra mode, according to some embodiments of the present disclosure.

FIG. 29 illustrates exemplary transform kernel for each sub-mode of SBT intra mode, according to some embodiments of the present disclosure.

FIG. 30 illustrates exemplary examples of more SBT intra sub-modes, according to some embodiments of the present disclosure.

FIG. 31 illustrates an exemplary example of the template for different SBT intra sub-modes, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

The Joint Video Experts Team (JVET) of the ITU-T Video Coding Expert Group (ITU-T VCEG) and the ISO/IEC Moving Picture Expert Group (ISO/IEC MPEG) is currently developing the Versatile Video Coding (VVC/H.266) standard. The VVC standard is aimed at doubling the compression efficiency of its predecessor, the High Efficiency Video Coding (HEVC/H.265) standard. In other words, VVC's goal is to achieve the same subjective quality as HEVC/H.265 using half the bandwidth.

To achieve the same subjective quality as HEVC/H.265 using half the bandwidth, the JVET has been developing technologies beyond HEVC using the joint exploration model (JEM) reference software. As coding technologies were incorporated into the JEM, the JEM achieved substantially higher coding performance than HEVC.

The VVC standard has been developed recently and continues to include more coding technologies that provide better compression performance. VVC is based on the same hybrid video coding system that has been used in modern video compression standards such as HEVC, H.264/AVC, MPEG2, H.263, etc.

A video is a set of static pictures (or “frames”) arranged in a temporal sequence to store visual information. A video capture device (e.g., a camera) can be used to capture and store those pictures in a temporal sequence, and a video playback device (e.g., a television, a computer, a smartphone, a tablet computer, a video player, or any end-user terminal with a function of display) can be used to display such pictures in the temporal sequence. Also, in some applications, a video capturing device can transmit the captured video to the video playback device (e.g., a computer with a monitor) in real-time, such as for surveillance, conferencing, or live broadcasting.

For reducing the storage space and the transmission bandwidth needed by such applications, the video can be compressed before storage and transmission and decompressed before the display. The compression and decompression can be implemented by software executed by a processor (e.g., a processor of a generic computer) or specialized hardware. The module for compression is generally referred to as an “encoder,” and the module for decompression is generally referred to as a “decoder.” The encoder and decoder can be collectively referred to as a “codec.” The encoder and decoder can be implemented as any of a variety of suitable hardware, software, or a combination thereof. For example, the hardware implementation of the encoder and decoder can include circuitry, such as one or more microprocessors, digital signal processors (DSPs), application-specific integrated circuits (ASICs), field-programmable gate arrays (FPGAs), discrete logic, or any combinations thereof. The software implementation of the encoder and decoder can include program codes, computer-executable instructions, firmware, or any suitable computer-implemented algorithm or process fixed in a computer-readable medium. Video compression and decompression can be implemented by various algorithms or standards, such as MPEG-1, MPEG-2, MPEG-4, H.26x series, or the like. In some applications, the codec can decompress the video from a first coding standard and re-compress the decompressed video using a second coding standard, in which case the codec can be referred to as a “transcoder.”

The video encoding process can identify and keep useful information that can be used to reconstruct a picture and disregard unimportant information for the reconstruction. If the disregarded, unimportant information cannot be fully reconstructed, such an encoding process can be referred to as “lossy.” Otherwise, it can be referred to as “lossless.” Most encoding processes are lossy, which is a tradeoff to reduce the needed storage space and the transmission bandwidth.

The useful information of a picture being encoded (referred to as a “current picture”) include changes with respect to a reference picture (e.g., a picture previously encoded and reconstructed). Such changes can include position changes, luminosity changes, or color changes of the pixels, among which the position changes are mostly concerned. Position changes of a group of pixels that represent an object can reflect the motion of the object between the reference picture and the current picture.

A picture coded without referencing another picture (i.e., it is its own reference picture) is referred to as an “I-picture.” A picture is referred to as a “P-picture” if some or all blocks (e.g., blocks that generally refer to portions of the video picture) in the picture are predicted using intra prediction or inter prediction with one reference picture (e.g., uni-prediction). A picture is referred to as a “B-picture” if at least one block in it is predicted with two reference pictures (e.g., bi-prediction).

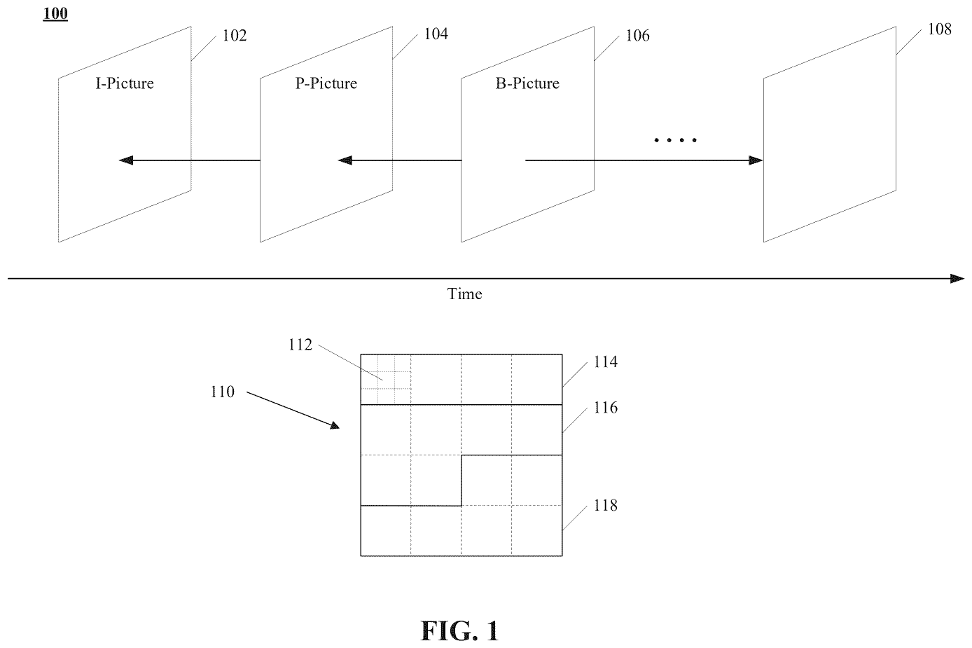

FIG. 1 illustrates structures of an exemplary video sequence 100, according to some embodiments of the present disclosure. Video sequence 100 can be a live video or a video having been captured and archived. Video sequence 100 can be a real-life video, a computer-generated video (e.g., computer game video), or a combination thereof (e.g., a real-life video with augmented-reality effects). Video sequence 100 can be inputted from a video capture device (e.g., a camera), a video archive (e.g., a video file stored in a storage device) containing previously captured video, or a video feed interface (e.g., a video broadcast transceiver) to receive video from a video content provider.

As shown in FIG. 1, video sequence 100 can include a series of pictures arranged temporally along a timeline, including pictures 102, 104, 106, and 108. Pictures 102-106 are continuous, and there are more pictures between pictures 106 and 108. In FIG. 1, picture 102 is an I-picture, the reference picture of which is picture 102 itself. Picture 104 is a P-picture, the reference picture of which is picture 102, as indicated by the arrow. Picture 106 is a B-picture, the reference pictures of which are pictures 104 and 108, as indicated by the arrows. In some embodiments, the reference picture of a picture (e.g., picture 104) may not be immediately preceding or following the picture. For example, the reference picture of picture 104 can be a picture preceding picture 102. It should be noted that the reference pictures of pictures 102-106 are only examples, and the present disclosure does not limit embodiments of the reference pictures as the examples shown in FIG. 1.

Typically, video codecs do not encode or decode an entire picture at one time due to the computing complexity of such tasks. Rather, they can split the picture into basic segments and encode or decode the picture segment by segment. Such basic segments are referred to as basic processing units (“BPUs”) in the present disclosure. For example, structure 110 in FIG. 1 shows an example structure of a picture of video sequence 100 (e.g., any of pictures 102-108). In structure 110, a picture is divided into 4×4 basic processing units, the boundaries of which are shown as dash lines. In some embodiments, the basic processing units can be referred to as “macroblocks” in some video coding standards (e.g., MPEG family, H.261, H.263, or H.264/AVC), or as “coding tree units” (“CTUs”) in some other video coding standards (e.g., H.265/HEVC or H.266/VVC). The basic processing units can have variable sizes in a picture, such as 128×128, 64×64, 32×32, 16×16, 4×8, 16×32, or any arbitrary shape and size of pixels. The sizes and shapes of the basic processing units can be selected for a picture based on the balance of coding efficiency and levels of details to be kept in the basic processing unit.

The basic processing units can be logical units, which can include a group of different types of video data stored in a computer memory (e.g., in a video frame buffer). For example, a basic processing unit of a color picture can include a luma component (Y) representing achromatic brightness information, one or more chroma components (e.g., Cb and Cr) representing color information, and associated syntax elements, in which the luma and chroma components can have the same size of the basic processing unit. The luma and chroma components can be referred to as “coding tree blocks” (“CTBs”) in some video coding standards (e.g., H.265/HEVC or H.266/VVC). Any operation performed to a basic processing unit can be repeatedly performed to each of its luma and chroma components.

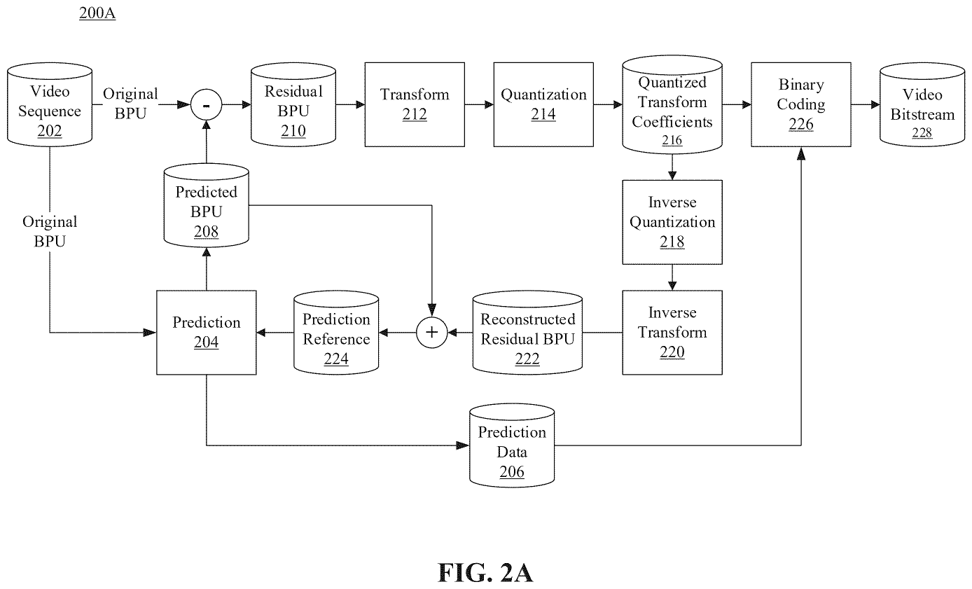

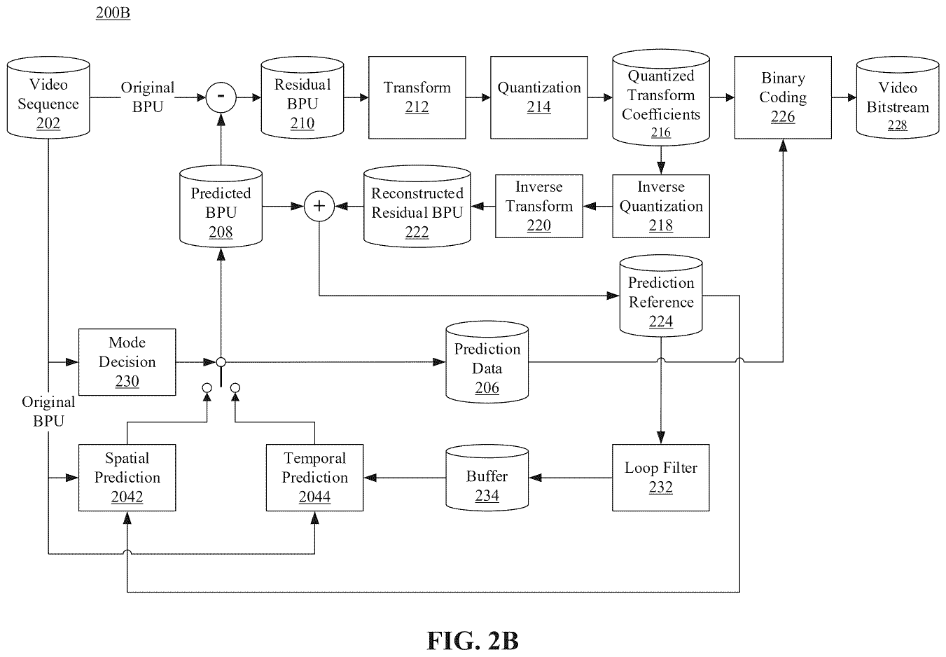

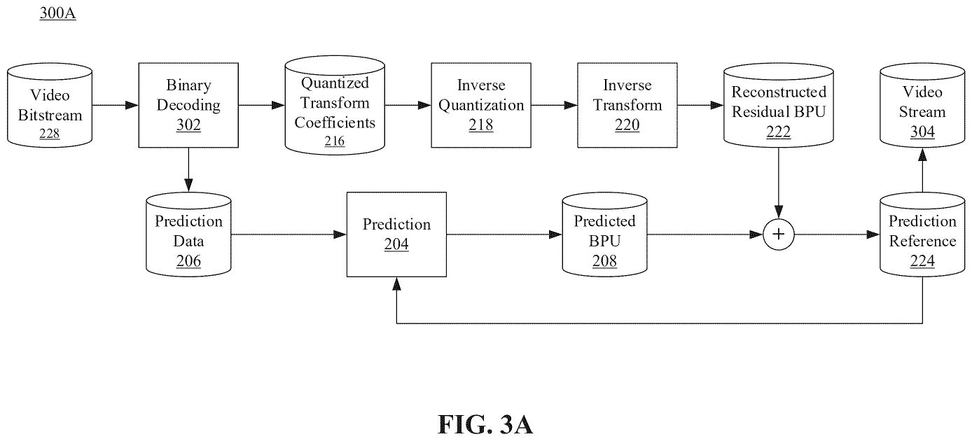

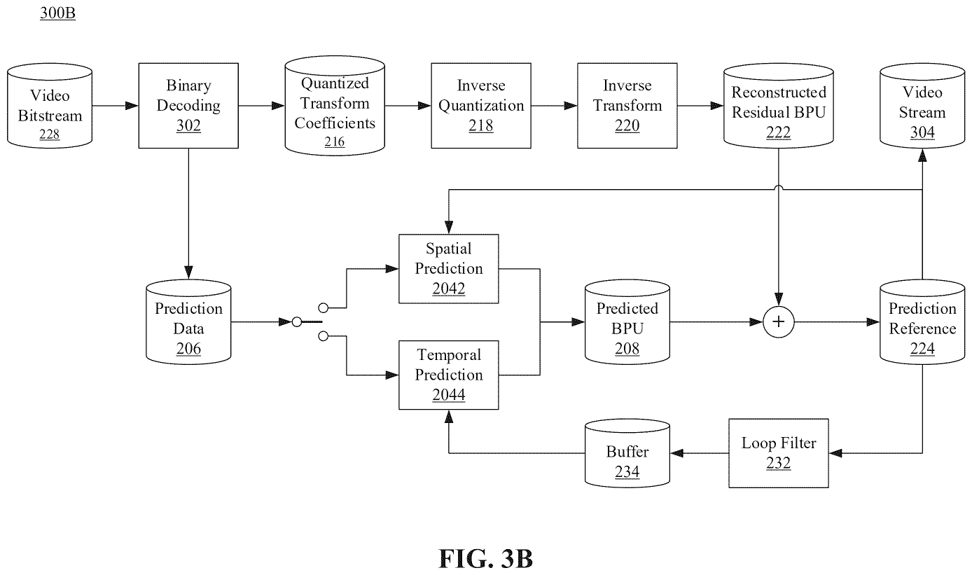

Video coding has multiple stages of operations, examples of which are shown in FIGS. 2A-2B and FIGS. 3A-3B. For each stage, the size of the basic processing units can still be too large for processing and thus can be further divided into segments referred to as “basic processing sub-units” in the present disclosure. In some embodiments, the basic processing sub-units can be referred to as “blocks” in some video coding standards (e.g., MPEG family, H.261, H.263, or H.264/AVC), or as “coding units” (“CUs”) in some other video coding standards (e.g., H.265/HEVC or H.266/VVC). A basic processing sub-unit can have the same or smaller size than the basic processing unit. Similar to the basic processing units, basic processing sub-units are also logical units, which can include a group of different types of video data (e.g., Y, Cb, Cr, and associated syntax elements) stored in a computer memory (e.g., in a video frame buffer). Any operation performed to a basic processing sub-unit can be repeatedly performed to each of its luma and chroma components. It should be noted that such division can be performed to further levels depending on processing needs. It should also be noted that different stages can divide the basic processing units using different schemes.

For example, at a mode decision stage (an example of which is shown in FIG. 2B), the encoder can decide what prediction mode (e.g., intra-picture prediction or inter-picture prediction) to use for a basic processing unit, which can be too large to make such a decision. The encoder can split the basic processing unit into multiple basic processing sub-units (e.g., CUs as in H.265/HEVC or H.266/VVC) and decide a prediction type for each individual basic processing sub-unit.

For another example, at a prediction stage (an example of which is shown in FIGS. 2A-2B), the encoder can perform prediction operation at the level of basic processing sub-units (e.g., CUs). However, in some cases, a basic processing sub-unit can still be too large to process. The encoder can further split the basic processing sub-unit into smaller segments (e.g., referred to as “prediction blocks” or “PBs” in H.265/HEVC or H.266/VVC), at the level of which the prediction operation can be performed.

For another example, at a transform stage (an example of which is shown in FIG. 2A and FIG. 2B), the encoder can perform a transform operation for residual basic processing sub-units (e.g., CUs). However, in some cases, a basic processing sub-unit can still be too large to process. The encoder can further split the basic processing sub-unit into smaller segments (e.g., referred to as “transform blocks” or “TBs” in H.265/HEVC or H.266/VVC), at the level of which the transform operation can be performed. It should be noted that the division schemes of the same basic processing sub-unit can be different at the prediction stage and the transform stage. For example, in H.265/HEVC or H.266/VVC, the prediction blocks and transform blocks of the same CU can have different sizes and numbers.

In structure 110 of FIG. 1, basic processing unit 112 is further divided into 3×3 basic processing sub-units, the boundaries of which are shown as dotted lines. Different basic processing units of the same picture can be divided into basic processing sub-units in different schemes.

In some implementations, to provide the capability of parallel processing and error resilience to video encoding and decoding, a picture can be divided into regions for processing, such that, for a region of the picture, the encoding or decoding process can depend on no information from any other region of the picture. In other words, each region of the picture can be processed independently. By doing so, the codec can process different regions of a picture in parallel, thus increasing the coding efficiency. Also, when data of a region is corrupted in the processing or lost in network transmission, the codec can correctly encode or decode other regions of the same picture without reliance on the corrupted or lost data, thus providing the capability of error resilience. In some video coding standards, a picture can be divided into different types of regions. For example, H.265/HEVC and H.266/VVC provide two types of regions: “slices” and “tiles.” It should also be noted that different pictures of video sequence 100 can have different partition schemes for dividing a picture into regions.

For example, in FIG. 1, structure 110 is divided into three regions 114, 116, and 118, the boundaries of which are shown as solid lines inside structure 110. Region 114 includes four basic processing units. Each of regions 116 and 118 includes six basic processing units. It should be noted that the basic processing units, basic processing sub-units, and regions of structure 110 in FIG. 1 are only examples, and the present disclosure does not limit embodiments thereof.

FIG. 2A illustrates a schematic diagram of an exemplary encoding process 200A, consistent with embodiments of the disclosure. For example, the encoding process 200A can be performed by an encoder. As shown in FIG. 2A, the encoder can encode video sequence 202 into video bitstream 228 according to process 200A. Similar to video sequence 100 in FIG. 1, video sequence 202 can include a set of pictures (referred to as “original pictures”) arranged in a temporal order. Similar to structure 110 in FIG. 1, each original picture of video sequence 202 can be divided by the encoder into basic processing units, basic processing sub-units, or regions for processing. In some embodiments, the encoder can perform process 200A at the level of basic processing units for each original picture of video sequence 202. For example, the encoder can perform process 200A in an iterative manner, in which the encoder can encode a basic processing unit in one iteration of process 200A. In some embodiments, the encoder can perform process 200A in parallel for regions (e.g., regions 114-118) of each original picture of video sequence 202.

In FIG. 2A, the encoder can feed a basic processing unit (referred to as an “original BPU”) of an original picture of video sequence 202 to prediction stage 204 to generate prediction data 206 and predicted BPU 208. The encoder can subtract predicted BPU 208 from the original BPU to generate residual BPU 210. The encoder can feed residual BPU 210 to transform stage 212 and quantization stage 214 to generate quantized transform coefficients 216. The encoder can feed prediction data 206 and quantized transform coefficients 216 to binary coding stage 226 to generate video bitstream 228. Components 202, 204, 206, 208, 210, 212, 214, 216, 226, and 228 can be referred to as a “forward path.” During process 200A, after quantization stage 214, the encoder can feed quantized transform coefficients 216 to inverse quantization stage 218 and inverse transform stage 220 to generate reconstructed residual BPU 222. The encoder can add reconstructed residual BPU 222 to predicted BPU 208 to generate prediction reference 224, which is used in prediction stage 204 for the next iteration of process 200A. Components 218, 220, 222, and 224 of process 200A can be referred to as a “reconstruction path.” The reconstruction path can be used to ensure that both the encoder and the decoder use the same reference data for prediction.

The encoder can perform process 200A iteratively to encode each original BPU of the original picture (in the forward path) and generate predicted reference 224 for encoding the next original BPU of the original picture (in the reconstruction path). After encoding all original BPUs of the original picture, the encoder can proceed to encode the next picture in video sequence 202.

Referring to process 200A, the encoder can receive video sequence 202 generated by a video capturing device (e.g., a camera). The term “receive” used herein can refer to receiving, inputting, acquiring, retrieving, obtaining, reading, accessing, or any action in any manner for inputting data.

At prediction stage 204, at a current iteration, the encoder can receive an original BPU and prediction reference 224 and perform a prediction operation to generate prediction data 206 and predicted BPU 208. Prediction reference 224 can be generated from the reconstruction path of the previous iteration of process 200A. The purpose of prediction stage 204 is to reduce information redundancy by extracting prediction data 206 that can be used to reconstruct the original BPU as predicted BPU 208 from prediction data 206 and prediction reference 224.

Ideally, predicted BPU 208 can be identical to the original BPU. However, due to non-ideal prediction and reconstruction operations, predicted BPU 208 is generally slightly different from the original BPU. For recording such differences, after generating predicted BPU 208, the encoder can subtract it from the original BPU to generate residual BPU 210. For example, the encoder can subtract values (e.g., greyscale values or RGB values) of pixels of predicted BPU 208 from values of corresponding pixels of the original BPU. Each pixel of residual BPU 210 can have a residual value as a result of such subtraction between the corresponding pixels of the original BPU and predicted BPU 208. Compared with the original BPU, prediction data 206 and residual BPU 210 can have fewer bits, but they can be used to reconstruct the original BPU without significant quality deterioration. Thus, the original BPU is compressed.

To further compress residual BPU 210, at transform stage 212, the encoder can reduce spatial redundancy of residual BPU 210 by decomposing it into a set of two-dimensional “base patterns,” each base pattern being associated with a “transform coefficient.” The base patterns can have the same size (e.g., the size of residual BPU 210). Each base pattern can represent a variation frequency (e.g., frequency of brightness variation) component of residual BPU 210. None of the base patterns can be reproduced from any combinations (e.g., linear combinations) of any other base patterns. In other words, the decomposition can decompose variations of residual BPU 210 into a frequency domain. Such a decomposition is analogous to a discrete Fourier transform of a function, in which the base patterns are analogous to the base functions (e.g., trigonometry functions) of the discrete Fourier transform, and the transform coefficients are analogous to the coefficients associated with the base functions.

Different transform algorithms can use different base patterns. Various transform algorithms can be used at transform stage 212, such as, for example, a discrete cosine transform, a discrete sine transform, or the like. The transform at transform stage 212 is invertible. That is, the encoder can restore residual BPU 210 by an inverse operation of the transform (referred to as an “inverse transform”). For example, to restore a pixel of residual BPU 210, the inverse transform can be multiplying values of corresponding pixels of the base patterns by respective associated coefficients and adding the products to produce a weighted sum. For a video coding standard, both the encoder and decoder can use the same transform algorithm (thus the same base patterns). Thus, the encoder can record only the transform coefficients, from which the decoder can reconstruct residual BPU 210 without receiving the base patterns from the encoder. Compared with residual BPU 210, the transform coefficients can have fewer bits, but they can be used to reconstruct residual BPU 210 without significant quality deterioration. Thus, residual BPU 210 is further compressed.

The encoder can further compress the transform coefficients at quantization stage 214. In the transform process, different base patterns can represent different variation frequencies (e.g., brightness variation frequencies). Because human eyes are generally better at recognizing low-frequency variation, the encoder can disregard information of high-frequency variation without causing significant quality deterioration in decoding. For example, at quantization stage 214, the encoder can generate quantized transform coefficients 216 by dividing each transform coefficient by an integer value (referred to as a “quantization scale factor”) and rounding the quotient to its nearest integer. After such an operation, some transform coefficients of the high-frequency base patterns can be converted to zero, and the transform coefficients of the low-frequency base patterns can be converted to smaller integers. The encoder can disregard the zero-value quantized transform coefficients 216, by which the transform coefficients are further compressed. The quantization process is also invertible, in which quantized transform coefficients 216 can be reconstructed to the transform coefficients in an inverse operation of the quantization (referred to as “inverse quantization”).

Because the encoder disregards the remainders of such divisions in the rounding operation, quantization stage 214 can be lossy. Typically, quantization stage 214 can contribute the most information loss in process 200A. The larger the information loss is, the fewer bits the quantized transform coefficients 216 can need. For obtaining different levels of information loss, the encoder can use different values of the quantization syntax element or any other syntax element of the quantization process.

At binary coding stage 226, the encoder can encode prediction data 206 and quantized transform coefficients 216 using a binary coding technique, such as, for example, entropy coding, variable length coding, arithmetic coding, Huffman coding, context-adaptive binary arithmetic coding, or any other lossless or lossy compression algorithm. In some embodiments, besides prediction data 206 and quantized transform coefficients 216, the encoder can encode other information at binary coding stage 226, such as, for example, a prediction mode used at prediction stage 204, syntax elements of the prediction operation, a transform type at transform stage 212, syntax elements of the quantization process (e.g., quantization syntax elements), an encoder control syntax element (e.g., a bitrate control syntax element), or the like. The encoder can use the output data of binary coding stage 226 to generate video bitstream 228. In some embodiments, video bitstream 228 can be further packetized for network transmission.

Referring to the reconstruction path of process 200A, at inverse quantization stage 218, the encoder can perform inverse quantization on quantized transform coefficients 216 to generate reconstructed transform coefficients. At inverse transform stage 220, the encoder can generate reconstructed residual BPU 222 based on the reconstructed transform coefficients. The encoder can add reconstructed residual BPU 222 to predicted BPU 208 to generate prediction reference 224 that is to be used in the next iteration of process 200A.

It should be noted that other variations of the process 200A can be used to encode video sequence 202. In some embodiments, stages of process 200A can be performed by the encoder in different orders. In some embodiments, one or more stages of process 200A can be combined into a single stage. In some embodiments, a single stage of process 200A can be divided into multiple stages. For example, transform stage 212 and quantization stage 214 can be combined into a single stage. In some embodiments, process 200A can include additional stages. In some embodiments, process 200A can omit one or more stages in FIG. 2A.

FIG. 2B illustrates a schematic diagram of another exemplary encoding process 200B, consistent with embodiments of the disclosure. Process 200B can be modified from process 200A. For example, process 200B can be used by an encoder conforming to a hybrid video coding standard (e.g., H.26x series). Compared with process 200A, the forward path of process 200B additionally includes mode decision stage 230 and divides prediction stage 204 into spatial prediction stage 2042 and temporal prediction stage 2044. The reconstruction path of process 200B additionally includes loop filter stage 232 and buffer 234.

Generally, prediction techniques can be categorized into two types: spatial prediction and temporal prediction. Spatial prediction (e.g., an intra-picture prediction or “intra prediction”) can use pixels from one or more already coded neighboring BPUs in the same picture to predict the current BPU. That is, prediction reference 224 in the spatial prediction can include the neighboring BPUs. The spatial prediction can reduce the inherent spatial redundancy of the picture. Temporal prediction (e.g., an inter-picture prediction or “inter prediction”) can use regions from one or more already coded pictures to predict the current BPU. That is, prediction reference 224 in the temporal prediction can include the coded pictures. The temporal prediction can reduce the inherent temporal redundancy of the pictures.

Referring to process 200B, in the forward path, the encoder performs the prediction operation at spatial prediction stage 2042 and temporal prediction stage 2044. For example, at spatial prediction stage 2042, the encoder can perform the intra prediction. For an original BPU of a picture being encoded, prediction reference 224 can include one or more neighboring BPUs that have been encoded (in the forward path) and reconstructed (in the reconstructed path) in the same picture. The encoder can generate predicted BPU 208 by extrapolating the neighboring BPUs. The extrapolation technique can include, for example, a linear extrapolation or interpolation, a polynomial extrapolation or interpolation, or the like. In some embodiments, the encoder can perform the extrapolation at the pixel level, such as by extrapolating values of corresponding pixels for each pixel of predicted BPU 208. The neighboring BPUs used for extrapolation can be located with respect to the original BPU from various directions, such as in a vertical direction (e.g., on top of the original BPU), a horizontal direction (e.g., to the left of the original BPU), a diagonal direction (e.g., to the down-left, down-right, up-left, or up-right of the original BPU), or any direction defined in the used video coding standard. For the intra prediction, prediction data 206 can include, for example, locations (e.g., coordinates) of the used neighboring BPUs, sizes of the used neighboring BPUs, syntax elements of the extrapolation, a direction of the used neighboring BPUs with respect to the original BPU, or the like.

For another example, at temporal prediction stage 2044, the encoder can perform the inter prediction. For an original BPU of a current picture, prediction reference 224 can include one or more pictures (referred to as “reference pictures”) that have been encoded (in the forward path) and reconstructed (in the reconstructed path). In some embodiments, a reference picture can be encoded and reconstructed BPU by BPU. For example, the encoder can add reconstructed residual BPU 222 to predicted BPU 208 to generate a reconstructed BPU. When all reconstructed BPUs of the same picture are generated, the encoder can generate a reconstructed picture as a reference picture. The encoder can perform an operation of “motion estimation” to search for a matching region in a scope (referred to as a “search window”) of the reference picture. The location of the search window in the reference picture can be determined based on the location of the original BPU in the current picture. For example, the search window can be centered at a location having the same coordinates in the reference picture as the original BPU in the current picture and can be extended out for a predetermined distance. When the encoder identifies (e.g., by using a pel-recursive algorithm, a block-matching algorithm, or the like) a region similar to the original BPU in the search window, the encoder can determine such a region as the matching region. The matching region can have different dimensions (e.g., being smaller than, equal to, larger than, or in a different shape) from the original BPU. Because the reference picture and the current picture are temporally separated in the timeline (e.g., as shown in FIG. 1), it can be deemed that the matching region “moves” to the location of the original BPU as time goes by. The encoder can record the direction and distance of such a motion as a “motion vector.” When multiple reference pictures are used (e.g., as picture 106 in FIG. 1), the encoder can search for a matching region and determine its associated motion vector for each reference picture. In some embodiments, the encoder can assign weights to pixel values of the matching regions of respective matching reference pictures.

The motion estimation can be used to identify various types of motions, such as, for example, translations, rotations, zooming, or the like. For inter prediction, prediction data 206 can include, for example, locations (e.g., coordinates) of the matching region, the motion vectors associated with the matching region, the number of reference pictures, weights associated with the reference pictures, or the like.

For generating predicted BPU 208, the encoder can perform an operation of “motion compensation.” The motion compensation can be used to reconstruct predicted BPU 208 based on prediction data 206 (e.g., the motion vector) and prediction reference 224. For example, the encoder can move the matching region of the reference picture according to the motion vector, in which the encoder can predict the original BPU of the current picture. When multiple reference pictures are used (e.g., as picture 106 in FIG. 1), the encoder can move the matching regions of the reference pictures according to the respective motion vectors and average pixel values of the matching regions. In some embodiments, if the encoder has assigned weights to pixel values of the matching regions of respective matching reference pictures, the encoder can add a weighted sum of the pixel values of the moved matching regions.

In some embodiments, the inter prediction can be unidirectional or bidirectional. Unidirectional inter predictions can use one or more reference pictures in the same temporal direction with respect to the current picture. For example, picture 104 in FIG. 1 is a unidirectional inter-predicted picture, in which the reference picture (e.g., picture 102) precedes picture 104. Bidirectional inter predictions can use one or more reference pictures at both temporal directions with respect to the current picture. For example, picture 106 in FIG. 1 is a bidirectional inter-predicted picture, in which the reference pictures (e.g., pictures 104 and 108) are at both temporal directions with respect to picture 104.

Still referring to the forward path of process 200B, after spatial prediction 2042 and temporal prediction stage 2044, at mode decision stage 230, the encoder can select a prediction mode (e.g., one of the intra prediction or the inter prediction) for the current iteration of process 200B. For example, the encoder can perform a rate-distortion optimization technique, in which the encoder can select a prediction mode to minimize a value of a cost function depending on a bit rate of a candidate prediction mode and distortion of the reconstructed reference picture under the candidate prediction mode. Depending on the selected prediction mode, the encoder can generate the corresponding predicted BPU 208 and predicted data 206.

In the reconstruction path of process 200B, if intra prediction mode has been selected in the forward path, after generating prediction reference 224 (e.g., the current BPU that has been encoded and reconstructed in the current picture), the encoder can directly feed prediction reference 224 to spatial prediction stage 2042 for later usage (e.g., for extrapolation of a next BPU of the current picture). The encoder can feed prediction reference 224 to loop filter stage 232, at which the encoder can apply a loop filter to prediction reference 224 to reduce or eliminate distortion (e.g., blocking artifacts) introduced during coding of the prediction reference 224. The encoder can apply various loop filter techniques at loop filter stage 232, such as, for example, deblocking, sample adaptive offsets, adaptive loop filters, or the like. The loop-filtered reference picture can be stored in buffer 234 (or “decoded picture buffer (DPB)”) for later use (e.g., to be used as an inter-prediction reference picture for a future picture of video sequence 202). The encoder can store one or more reference pictures in buffer 234 to be used at temporal prediction stage 2044. In some embodiments, the encoder can encode syntax elements of the loop filter (e.g., a loop filter strength) at binary coding stage 226, along with quantized transform coefficients 216, prediction data 206, and other information.

FIG. 3A illustrates a schematic diagram of an exemplary decoding process 300A, consistent with embodiments of the disclosure. Process 300A can be a decompression process corresponding to the compression process 200A in FIG. 2A. In some embodiments, process 300A can be similar to the reconstruction path of process 200A. A decoder can decode video bitstream 228 into video stream 304 according to process 300A. Video stream 304 can be very similar to video sequence 202. However, due to the information loss in the compression and decompression process (e.g., quantization stage 214 in FIG. 2A and FIG. 2B), generally, video stream 304 is not identical to video sequence 202. Similar to processes 200A and 200B in FIG. 2A and FIG. 2B, the decoder can perform process 300A at the level of basic processing units (BPUs) for each picture encoded in video bitstream 228. For example, the decoder can perform process 300A in an iterative manner, in which the decoder can decode a basic processing unit in one iteration of process 300A. In some embodiments, the decoder can perform process 300A in parallel for regions (e.g., regions 114-118) of each picture encoded in video bitstream 228.

In FIG. 3A, the decoder can feed a portion of video bitstream 228 associated with a basic processing unit (referred to as an “encoded BPU”) of an encoded picture to binary decoding stage 302. At binary decoding stage 302, the decoder can decode the portion into prediction data 206 and quantized transform coefficients 216. The decoder can feed quantized transform coefficients 216 to inverse quantization stage 218 and inverse transform stage 220 to generate reconstructed residual BPU 222. The decoder can feed prediction data 206 to prediction stage 204 to generate predicted BPU 208. The decoder can add reconstructed residual BPU 222 to predicted BPU 208 to generate predicted reference 224. In some embodiments, predicted reference 224 can be stored in a buffer (e.g., a decoded picture buffer in a computer memory). The decoder can feed predicted reference 224 to prediction stage 204 for performing a prediction operation in the next iteration of process 300A.

The decoder can perform process 300A iteratively to decode each encoded BPU of the encoded picture and generate predicted reference 224 for encoding the next encoded BPU of the encoded picture. After decoding all encoded BPUs of the encoded picture, the decoder can output the picture to video stream 304 for display and proceed to decode the next encoded picture in video bitstream 228.

At binary decoding stage 302, the decoder can perform an inverse operation of the binary coding technique used by the encoder (e.g., entropy coding, variable length coding, arithmetic coding, Huffman coding, context-adaptive binary arithmetic coding, or any other lossless compression algorithm). In some embodiments, besides prediction data 206 and quantized transform coefficients 216, the decoder can decode other information at binary decoding stage 302, such as, for example, a prediction mode, syntax elements of the prediction operation, a transform type, syntax elements of the quantization process (e.g., quantization syntax elements), an encoder control syntax element (e.g., a bitrate control syntax element), or the like. In some embodiments, if video bitstream 228 is transmitted over a network in packets, the decoder can depacketize video bitstream 228 before feeding it to binary decoding stage 302.

FIG. 3B illustrates a schematic diagram of another exemplary decoding process 300B, consistent with embodiments of the disclosure. Process 300B can be modified from process 300A. For example, process 300B can be used by a decoder conforming to a hybrid video coding standard (e.g., H.26x series). Compared with process 300A, process 300B additionally divides prediction stage 204 into spatial prediction stage 2042 and temporal prediction stage 2044 and additionally includes loop filter stage 232 and buffer 234.

In process 300B, for an encoded basic processing unit (referred to as a “current BPU”) of an encoded picture (referred to as a “current picture”) that is being decoded, prediction data 206 decoded from binary decoding stage 302 by the decoder can include various types of data, depending on what prediction mode was used to encode the current BPU by the encoder. For example, if intra prediction was used by the encoder to encode the current BPU, prediction data 206 can include a prediction mode indicator (e.g., a flag value) indicative of the intra prediction, syntax elements of the intra prediction operation, or the like. The syntax elements of the intra prediction operation can include, for example, locations (e.g., coordinates) of one or more neighboring BPUs used as a reference, sizes of the neighboring BPUs, syntax elements of extrapolation, a direction of the neighboring BPUs with respect to the original BPU, or the like. For another example, if inter prediction was used by the encoder to encode the current BPU, prediction data 206 can include a prediction mode indicator (e.g., a flag value) indicative of the inter prediction, syntax elements of the inter prediction operation, or the like. The syntax elements of the inter prediction operation can include, for example, the number of reference pictures associated with the current BPU, weights respectively associated with the reference pictures, locations (e.g., coordinates) of one or more matching regions in the respective reference pictures, one or more motion vectors respectively associated with the matching regions, or the like.

Based on the prediction mode indicator, the decoder can decide whether to perform a spatial prediction (e.g., the intra prediction) at spatial prediction stage 2042 or a temporal prediction (e.g., the inter prediction) at temporal prediction stage 2044. The details of performing such spatial prediction or temporal prediction are described in FIG. 2B and will not be repeated hereinafter. After performing such spatial prediction or temporal prediction, the decoder can generate predicted BPU 208. The decoder can add predicted BPU 208 and reconstructed residual BPU 222 to generate prediction reference 224, as described in FIG. 3A.

In process 300B, the decoder can feed predicted reference 224 to spatial prediction stage 2042 or temporal prediction stage 2044 for performing a prediction operation in the next iteration of process 300B. For example, if the current BPU is decoded using the intra prediction at spatial prediction stage 2042, after generating prediction reference 224 (e.g., the decoded current BPU), the decoder can directly feed prediction reference 224 to spatial prediction stage 2042 for later usage (e.g., for extrapolation of a next BPU of the current picture). If the current BPU is decoded using the inter prediction at temporal prediction stage 2044, after generating prediction reference 224 (e.g., a reference picture in which all BPUs have been decoded), the decoder can feed prediction reference 224 to loop filter stage 232 to reduce or eliminate distortion (e.g., blocking artifacts). The decoder can apply a loop filter to prediction reference 224, in a way as described in FIG. 2B. The loop-filtered reference picture can be stored in buffer 234 (e.g., a decoded picture buffer (DPB) in a computer memory) for later use (e.g., to be used as an inter-prediction reference picture for a future encoded picture of video bitstream 228). The decoder can store one or more reference pictures in buffer 234 to be used at temporal prediction stage 2044. In some embodiments, prediction data can further include syntax elements of the loop filter (e.g., a loop filter strength). In some embodiments, prediction data includes syntax elements of the loop filter when the prediction mode indicator of prediction data 206 indicates that inter prediction was used to encode the current BPU.

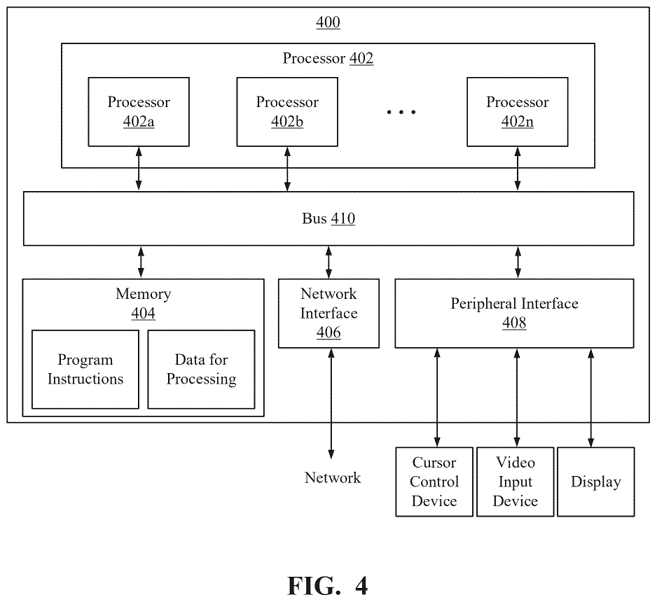

FIG. 4 is a block diagram of an exemplary apparatus 400 for encoding or decoding a video, consistent with embodiments of the disclosure. As shown in FIG. 4, apparatus 400 can include processor 402. When processor 402 executes instructions described herein, apparatus 400 can become a specialized machine for video encoding or decoding. Processor 402 can be any type of circuitry capable of manipulating or processing information. For example, processor 402 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 402 can also be a set of processors grouped as a single logical component. For example, as shown in FIG. 4, processor 402 can include multiple processors, including processor 402a, processor 402b, and processor 402n.

Apparatus 400 can also include memory 404 configured to store data (e.g., a set of instructions, computer codes, intermediate data, or the like). For example, as shown in FIG. 4, the stored data can include program instructions (e.g., program instructions for implementing the stages in processes 200A, 200B, 300A, or 300B) and data for processing (e.g., video sequence 202, video bitstream 228, or video stream 304). Processor 402 can access the program instructions and data for processing (e.g., via bus 410) and execute the program instructions to perform an operation or manipulation on the data for processing. Memory 404 can include a high-speed random-access storage device or a non-volatile storage device. In some embodiments, memory 404 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 404 can also be a group of memories (not shown in FIG. 4) grouped as a single logical component.

Bus 410 can be a communication device that transfers data between components inside apparatus 400, such as an internal bus (e.g., a CPU-memory bus), an external bus (e.g., a universal serial bus port, a peripheral component interconnect express port), or the like.

For ease of explanation without causing ambiguity, processor 402 and other data processing circuits are collectively referred to as a “data processing circuit” in this disclosure. The data processing circuit can be implemented entirely as hardware, or as a combination of software, hardware, or firmware. In addition, the data processing circuit can be a single independent module or can be combined entirely or partially into any other component of apparatus 400.

Apparatus 400 can further include network interface 406 to provide wired or wireless communication with a network (e.g., the Internet, an intranet, a local area network, a mobile communications network, or the like). In some embodiments, network interface 406 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, a near-field communication (“NFC”) adapter, a cellular network chip, or the like.

In some embodiments, optionally, apparatus 400 can further include peripheral interface 408 to provide a connection to one or more peripheral devices. As shown in FIG. 4, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface coupled to a video archive), or the like.

It should be noted that video codecs (e.g., a codec performing process 200A, 200B, 300A, or 300B) can be implemented as any combination of any software or hardware modules in apparatus 400. For example, some or all stages of process 200A, 200B, 300A, or 300B can be implemented as one or more software modules of apparatus 400, such as program instructions that can be loaded into memory 404. For another example, some or all stages of process 200A, 200B, 300A, or 300B can be implemented as one or more hardware modules of apparatus 400, such as a specialized data processing circuit (e.g., an FPGA, an ASIC, an NPU, or the like).

An Enhanced Compression Model (ECM) has been proposed and been used as a new software base for developing tools beyond the VVC standard.

In the present disclosure, intra prediction can be used for video coding.

According to the VVC standard, the luma component can be predicted by multiple intra prediction modes. These include planar mode, DC mode, angular mode, Multiple Reference Line (MRL) prediction mode, Intra Sub-partition (ISP) mode, Matrix-based Intra Prediction (MIP) mode and Intra Block Copy (IBC) mode.

In ECM, several video compression technologies beyond VVC are being explored. In ECM, some intra prediction modes are extended. And some new intra prediction modes are added, such as intra Template Matching (intra TMP) mode, Decoder-side Intra Mode Derivation (DIMD) mode, Template-based Intra Mode Derivation (TIMD) mode, Spatial Geometric Partition (SGPM) mode, Extrapolation filter-based intra prediction (EIP) mode and Neural network-based intra prediction (NNIP) mode.

In the present disclosure, a planar mode can be used for intra prediction.

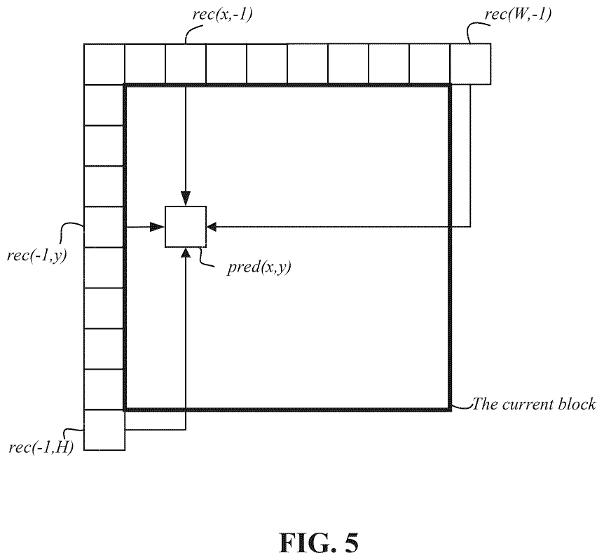

In the planar mode, the predicted value of the current sample is obtained from the reconstructed values of 4 reference samples: the left reference sample in the same row as the current sample, the above reference sample in the same column as the current sample, the reference sample on the bottom-left position adjacent to the current block and the reference sample on the top-right position adjacent to the current block. FIG. 5 illustrates exemplary reference samples used in planar mode, according to some embodiments of the present disclosure. As shown in FIG. 5, for example, using pred (x, y) to represent the predicted value of the current sample, using H to represent the height of the current block, and using W to represent the width of the current block, then the reconstructed values of the four reference samples used in planar mode can be respectively represented as rec(−1,y), rec(x,−1), rec(−1, H) and rec(W,−1), where (x, y) represents the coordinate positions of the current sample relative to the top-left position within the current block.

The planar mode generates the predicted value of the current sample based on equations (1) to (3). In equation (1), an intermediate value predV(x, y) is obtained from rec(x,−1) and rec(−1, H); in equation (2), another intermediate value predH(x, y) is obtained from rec(−1, y) and rec(W,−1); finally, the two intermediate values are used to generate the predicted value of the current sample based on equation (3).

$$pred ( x , y ) = ( ( H - 1 - y ) * rec ( x , - 1 ) + ( y + 1 ) * rec ( - 1 , H ) ) << {log}_{2} W \qquad ( 1 )$$

$$pred ( x , y ) = ( ( W - 1 - x ) * rec ( - 1 , y ) + ( x + 1 ) * rec ( W , - 1 ) ) << {log}_{2} H \qquad ( 2 )$$

$$pred ( x , y ) = ( ( W - 1 - x ) * rec ( - 1 , y ) + ( x + 1 ) * rec ( W , - 1 ) ) << {log}_{2} H \qquad ( 3 )$$

The planar mode can be represented as intra prediction mode index 0.

In ECM, two additional planar modes where only the horizontal interpolation or only the vertical interpolation are used to obtain the predicted samples for luma.

For planar horizontal mode, only the horizontal linear interpolation is performed based on the left reference sample and the top-right reference sample to predict the current sample as:

$$pred ( x , y ) = ( ( W - 1 - x ) * rec ( - 1 , y ) + ( x + 1 ) * rec ( W , - 1 ) + ( W >> 1 ) ) >> {log}_{2} ( W ) \qquad ( 4 )$$

For planar vertical mode, only the vertical linear interpolation is performed based on the above reference sample and the bottom-left reference sample to predict the current sample as:

$$pred ( x , y ) = ( ( H - 1 - y ) * rec ( x , - 1 ) + ( y + 1 ) * rec ( - 1 , H ) + ( H ≫ 1 ) ) ≫ {log}_{2} ( H ) \qquad ( 5 )$$

In the present disclosure, a DC mode can be used for intra prediction.

In the DC mode, an average reconstructed value of the left and above reference samples to the current block is used for prediction generation. In HEVC, every intra-coded block has a square shape and the length of each of its side (i.e. left and above) is a power of 2. Thus, no division operations are required to calculate the average value. In VVC, blocks can have a rectangular shape that necessitates the use of a division operation per block in the general case. To avoid division operations for DC prediction, only the longer side is used to compute the average value for non-square blocks. And for square blocks reference samples from both left and above sides are used to compute the average value.

The DC mode can be represented as intra prediction mode index 1.

In the present disclosure, an angular mode can be used for intra prediction.

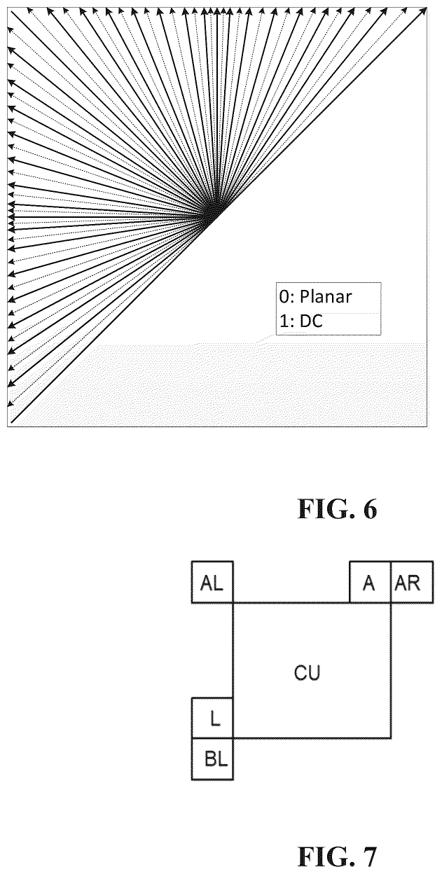

Angular intra prediction is a directional intra prediction method, which is extended from a prior implementation according to the HEVC standard. To capture the arbitrary edge directions presented in natural video, the VVC standard extends the number of angular intra prediction modes from 33 (as used in HEVC) to 65. FIG. 6 illustrates angular intra prediction modes, according to embodiments of the present disclosure. The modes added in VVC are illustrated in broken lines.

The 65 angular modes can be represented as intra prediction mode index 2 to index 66.

The planar mode, DC mode and the 65 angle modes can be referred to as conventional intra prediction mode in this disclosure.

In order to reduce the signaling cost, a most probable mode (MPM) list based signaling method is used to signal the conventional intra prediction modes.

According to the VVC standard, to keep the complexity of the MPM list generation low, an intra mode coding method with 6 MPMs is used by considering two available adjacent intra modes.

A unified 6-MPM list is used for intra blocks. The MPM list is constructed based on intra modes of the left and above adjacent blocks. Suppose the mode of the left is denoted as Left and the mode of the above block is denoted as Above, the unified MPM list is constructed as follows:
When an adjacent block is not available, its intra mode is set to Planar by default.
If both modes Left and Above are non-angular modes:
   MPM list→{Planar, DC, V, H, V−4, V+4}
If one of modes Left and Above is angular mode, and the other is non-angular:
   Set a mode Max as the larger mode in Left and Above
   MPM list→{Planar, Max, Max−1, Max+1, Max−2, Max+2}
If Left and Above are both angular and they are different:
   Set a mode Max as the larger mode in Left and Above
   Set a mode Min as the smaller mode in Left and Above
   If Max-Min is equal to 1:
      MPM list→{Planar, Left, Above, Min−1, Max+1, Min−2}
   Otherwise, if Max-Min is greater than or equal to 62:
      MPM list→{Planar, Left, Above, Min+1, Max−1, Min+2}
   Otherwise, if Max-Min is equal to 2:
      MPM list→{Planar, Left, Above, Min+1, Min−1, Max+1}
   Otherwise:
      MPM list→{Planar, Left, Above, Min−1,−Min+1, Max−1}
If Left and Above are both angular and they are the same:
   MPM list→{Planar, Left, Left−1, Left+1, Left−2, Left+2}.

For a CU, a MPM flag is signaled to indicate whether an intra prediction mode in the MPM list is used. If the MPM flag is true, for example a value of the MPM flag equals to a first value (such as 1), an index is signaled to indicate which intra prediction mode in the MPM list is used.

According to an ECM proposal, secondary MPM lists is introduced. The existing primary MPM (PMPM) list consists of 6 entries and the secondary MPM (SMPM) list includes 16 entries. A general MPM list with 22 entries is constructed first, and then the first 6 entries in this general MPM list are included into the PMPM list, and the rest of entries form the SMPM list. The first entry in the general MPM list is the Planar mode. FIG. 7 illustrates adjacent blocks (L, A, BL, AR, AL) used in the derivation of a general MPM list, according to some embodiments of the present disclosure. The remaining entries are composed of the intra modes of the left (L), above (A), below-left (BL), above-right (AR), and above-left (AL) adjacent blocks as shown in FIG. 7, and DIMD modes which are sorted in ascending order of SAD cost. Up to 5 modes with the smallest SAD cost are added. The SAD cost is computed between the prediction and the reconstruction samples of the template. The sorted directional modes with added offset are added into the general MPM list, and then the default modes, until the general MPM list with 22 entries is constructed.

If a block is vertically oriented, the order of neighbouring blocks is A, L, BL, AR, AL; otherwise, it is L, A, BL, AR, AL.

For a CU, a PMPM flag is signaled to indicate whether an intra prediction mode in the PMPM list is used. If the PMPM flag is true, for example a value of the PMPM flag equals to a first value (such as 1), an index is signaled to indicate which intra prediction mode in the PMPM list is used. If the PMPM flag is false, for example the value of the PMPM flag equals to a second value (such as 0), another SMPM flag is signaled to indicate whether an intra prediction mode in the SMPM list is used. If the SMPM flag is true, for example a value of the SMPM flag equals to a first value (such as 1), another index is signaled to indicate which intra prediction mode in the SMPM list is used.

According to an ECM proposal, the intra modes derived by DIMD method can also be added to the MPM list.

According to an ECM proposal, the intra modes of the non-adjacent blocks can also be added to the MPM list.

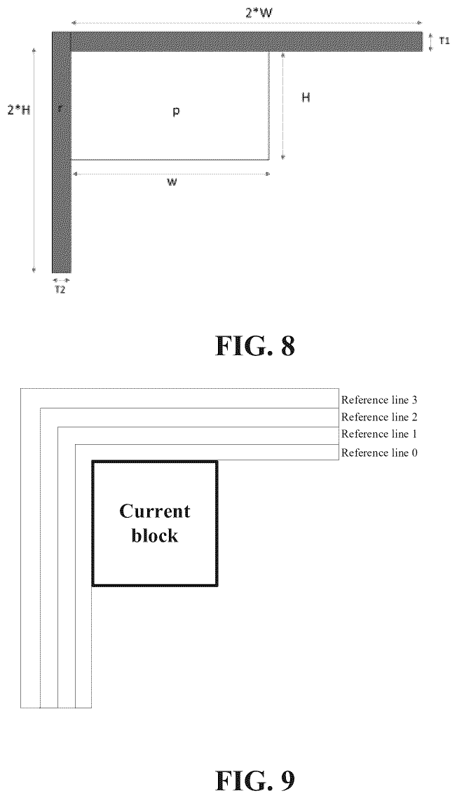

According to an ECM proposal, some of the conventional intra prediction modes (planar, DC, and the 65 angular modes) may be replaced by matrix based intra prediction modes which called position dependent prediction replacement (PDP replacement). In the matrix based intra prediction mode, a matrix of weights, which are defined for a block shape and intra mode index, is introduced. Those weights are multiplied by the neighbour reference template to derive the predicted values of the current block. FIG. 8 illustrates an exemplary L shaped neighborhood for a given predicted block, according to some embodiments of the present disclosure. As shown in FIG. 8, the weights are applied to the reference samples of the L shaped causal adjacent template.

The reference samples in the causal adjacent are denoted as r, and F (x, y) is the matrix of weights. Then the predicted value pred (x, y) can be derived based on:

$$pred ( x , y ) = {\sum }_{k} F ( x , y , k ) * r ( k ) \qquad ( 6 )$$

where k denotes the index of the reference sample in the template.

The prediction is used for block size with both width and height up to 32 (except for 4×32,32×4, 8×32 and 32×8). The template size is 2 for blocks with both width and height up to 16 and the modes with index 0, 1, and (2+2*k) are replaced. For other blocks, template size is set to 1 and the modes with index 0, 1, and (2+4*k) are replaced. The prediction is only performed for 16×16 positions, and the rest of the samples are generated by bilinear interpolation. For all block sizes, block shape and mode-based symmetry is used. Reference length is set to W and H for modes with index greater than 18 and less than 50 and set to 2*W and 2*H for other modes.

According to an ECM proposal, an intra fusion mode with different reference lines is applied. This intra prediction method derives predicted samples as a weighted combination of multiple predictors generated from different reference lines. In this process multiple intra predictors are generated and then fused by weighted averaging. For angular intra prediction modes including the single mode case of TIMD and DIMD, the proposed method derives intra prediction by weighting intra predictions obtained from multiple reference lines represented as p_{fusion}=W₀pₗᵢₙₑ+W₁Pₗᵢₙₑ₊₁, where pₗᵢₙₑ is the intra prediction from the default reference line and pₗᵢₙₑ₊₁ is the prediction from the line above the default reference line. The weights are set as w₀=¾ and w₁=¼.

The angular intra prediction fusion method is applied to luma blocks when angular intra mode has non-integer slope (required reference samples interpolation) and the block size is greater than 16, it is used with MRL and not applied for ISP coded blocks.

In the present disclosure, multiple reference line (MRL) can be used in intra prediction.

In VVC, multiple reference line (MRL) intra prediction uses more reference lines for intra prediction. FIG. 9 illustrates an example of four reference lines neighboring to a prediction block, according to some embodiments of the present disclosure. As shown in FIG. 9, in MRL, 2 additional lines (reference line 1 and reference line 3) can be used. The index of selected reference line is signalled and used to generate intra prediction samples.

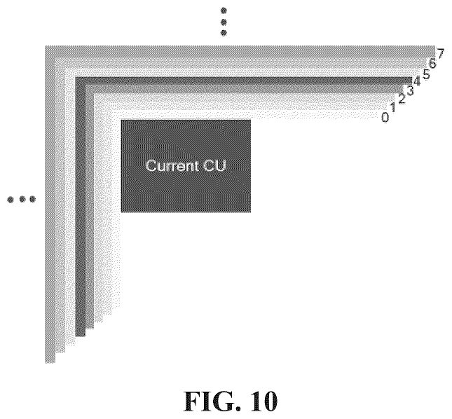

According to an ECM proposal, MRL list is extended to include more reference lines for intra prediction. FIG. 10 illustrates an exemplary extended MRL candidate list, according to some embodiments of the present disclosure. As shown in FIG. 10, the extended reference line list consists of line indices {1, 3, 5, 7, 12}. For template-based intra mode derivation (TIMD), instead of the full MRL candidate list, only the first two reference line candidates, i.e., {1, 3}, are used.

According to an ECM proposal, a template-based multiple reference line intra prediction (TMRL) mode combines reference line and prediction mode together and uses a template matching method to construct a list of candidate combinations. An index to the candidate combination list is coded to indicate which reference line and prediction mode is used in coding the current block. The regular multiple reference line (MRL) for the non-TIMD part is replaced by TMRL mode.

In the present disclosure, intra sub-partitions (ISP) can be used in intra prediction.

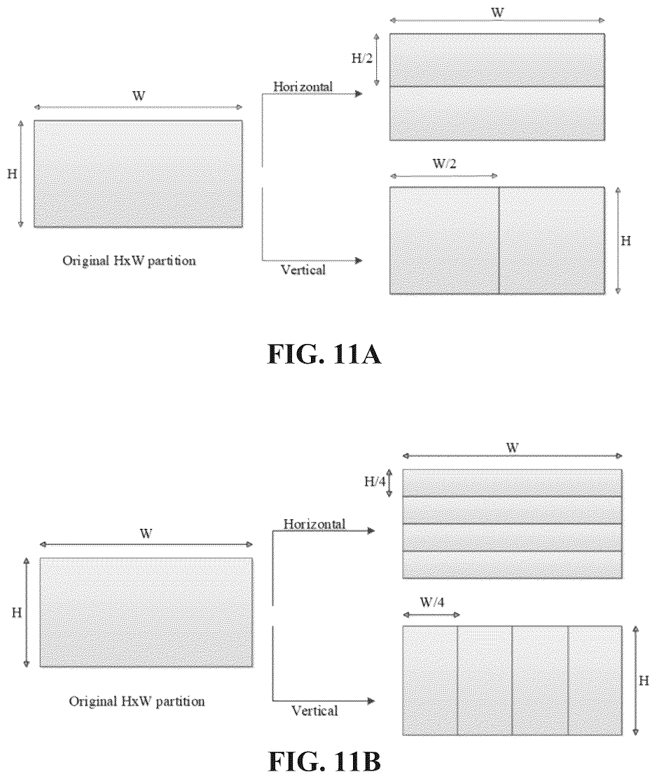

FIG. 11A and FIG. 11B illustrate examples of sub-partition depending on the block size, according to some embodiments of the present disclosure. In VVC, the intra sub-partitions (ISP) divides luma intra-predicted blocks vertically or horizontally into 2 sub-partitions (as shown in FIG. 11A) or 4 sub-partitions (as shown in FIG. 11B) depending on the block size. For each sub-partition, reconstructed samples are obtained by adding the residual signal to the prediction signal. A residual signal is generated by processes such as entropy decoding, inverse quantization and inverse transformation. Therefore, the reconstructed sample values of each sub-partition are available to generate the prediction of the next sub-partition, and each sub-partition is processed repeatedly. In addition, the first sub-partition to be processed is the one containing the top-left sample of the CU and then continuing downwards (horizontal split) or rightwards (vertical split). As a result, reference samples used to generate the sub-partitions prediction signals are only located at the left and above sides of the lines.

In ISP mode, all 67 conventional intra prediction modes (planar mode, DC mode and 65 angular modes) are allowed. All sub-partitions in a block share the same intra prediction mode.

In the present disclosure, matrix-based intra prediction (MIP) can be used in intra prediction.

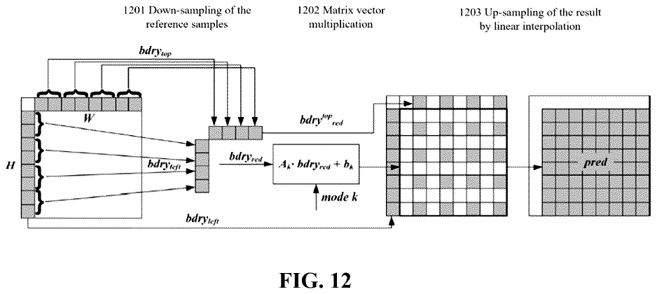

In MIP method, for predicting the samples of a block of width W and height H, MIP takes one line of H reconstructed adjacent boundary samples left of the block and one line of W reconstructed adjacent boundary samples above the block as input. FIG. 12 illustrates an exemplar matrix weighed intra prediction process, according to some embodiments of the present disclosure. As shown in FIG. 12, the generation of the prediction signal includes three steps: step 1201 of down-sampling of the reference samples, step 1202 of matrix vector multiplication, and step 1203 of up-sampling of the result by linear interpolation.

In the present disclosure, intra block copy (IBC) can be used in intra prediction.

Intra block copy (IBC) is a tool adopted in VVC. It is well known that it significantly improves the coding efficiency of screen content materials. Since IBC mode is implemented as a block level coding mode, block matching (BM) is performed at the encoder to find the optimal block vector for each CU. A block vector is used to indicate the displacement from the current block to a reference block, which is already reconstructed inside the current picture. The luma block vector of an IBC-coded CU is in integer precision. The chroma block vector rounds to integer precision as well. When combined with AMVR, the IBC mode can switch between 1-pel and 4-pel motion vector precisions.

According to an ECM proposal, the IBC mode can also be applied to camera captured content, and block vector of an IBC-coded CU is extended to fractional precision.

In the present disclosure, intra template matching (intra TMP) can be used in intra prediction.

According to an ECM proposal, intra template matching prediction (Intra TMP) is a special intra prediction mode that copies the best prediction block from the reconstructed part of the current picture, whose template matches the current template. That is, the block vector of the current block is derived by the template in both encoder side and decoder side instead of signaling. For a predefined search range, the encoder searches for the most similar template to the current template in a reconstructed part of the current frame and uses the corresponding block as a prediction block. And the vector which can represent the position of the matched block is stored as the block vector of the current block. The encoder then signals the usage of this mode, and the same prediction operation is performed at the decoder side.

The prediction signal is generated by matching the L-shaped, Top-only or Left-Only template of the current block with another block in a predefined search area. The template includes the causal adjacent samples of the current block.

Sum of absolute differences (SAD) is used as a cost function. Within each region, the decoder searches for the template that has least SAD with respect to the current one and uses its corresponding block as a prediction block. A block vector is stored for the current block.

Intra TMP employs an implicit merge mode, where merge candidates are considered without signaling a merge flag or index. Specifically, the reference positions pointed by the block vectors of all the adjacent and non-adjacent merge candidates (coded in Intra TMP or IBC mode) are used as additional candidates beyond the default search areas, up to 10 merge candidates are derived from the neighboring PUs and by prioritizing the candidates outside the Intra TMP search range. In addition, up to 20 auto-relocated block vector prediction (AR-BVP) candidates are constructed to get more reference positions.

The following modes are supported for intra TMP:
1. Single predictor: A single predictor is selected from the candidate list.
2. Fusion of multiple predictors: multiple predictors are blended multiple to derive the final prediction block. The blending weights are either computed from the template matching cost of each predictor, or with Wiener-filter based weight derivation method.
3. Sub-pel precision: When single predictor is used, sub-pel precisions are supported. A new candidate list is constructed by including the selected integer block vector and surrounding ½-pel and 1-4-pel sub-pel positions. The list is sorted based on the same cost function used for the integer by search. After that, the first two candidates are allowed to be selected with one single flag being signaled from encoder to decoder.
4. Linear filter model: A linear filter can be learned between the reference template and current template and be applied the linear mode1 to reference block. This mode can be used for single predictor when sub-pel precision is not used.

Additionally, Intra TMP with local illumination compensation is allowed. When LIC is used for a given CU, the Intra TMP search process employs MRSAD rather than SAD distortion function.

In the present disclosure, decoder side intra mode derivation mode (DIMD) can be used in intra prediction.

In ECM, a decoder side intra mode derivation (DIMD) mode is applied. Up to N intra modes are derived from the reconstructed neighbor samples, and those predictors are combined with the non-directional predictor (planar or BV based predictor) with the weights derived from the histogram of gradients.

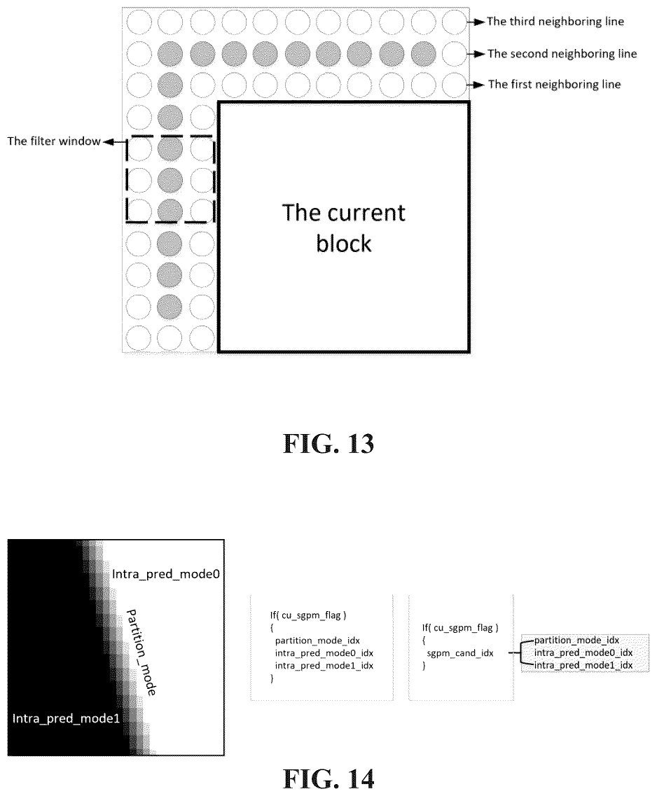

FIG. 13 illustrates exemplary samples used for calculating the gradients, according to some embodiments of the present disclosure. As shown in FIG. 13, to build the DIMD histogram for a block, a gradient analysis is performed on the samples of L-shaped template of the second neighboring line surrounding the block, which are depicted as grey circles in FIG. 13. For each available reconstructed pixel of the template, a horizontal gradient and a vertical gradient, Gx and Gy, are carried out by applying horizontal and vertical Sobel filters as follows:

$${F}_{hor} = [ \begin{matrix}1 & 0 & - 1 \\ 2 & 0 & - 2 \\ 1 & 0 & - 1\end{matrix} ] and {F}_{ver} = [ \begin{matrix}- 1 & - 2 & - 1 \\ 0 & 0 & 0 \\ 1 & 2 & 1\end{matrix} ]$$

For each sample in the template, for which the horizontal gradient Gx and the vertical gradient Gy are calculated, the intensity (G) and the orientation (O) of the gradients are further calculated using Gx and Gy based on the following:

$$G = \vert {G}_{x} \vert + \vert {G}_{y} \vert \qquad ( 7 )$$

$$O = a tan ( \frac{{G}_{y}}{{G}_{x}} ) \qquad ( 8 )$$

The orientation of gradients O is then converted into the closest intra angular prediction mode, used to index a histogram which is first initialized to zero. And the histogram value at that intra angular prediction mode is increased by G. Once all the samples in the template have been processed, the histogram will contain cumulative values of gradient intensities, for each intra angular prediction mode. Up to N angular modes with the highest and second highest amplitude values will be selected and are used for the following prediction fusion process. If the maximum amplitude value in the histogram is 0, then the Planar mode is selected as intra prediction mode for the current block.

The decision among the non-directional modes is taken according to the template cost. Specifically, the block vectors of all adjacent and non-adjacent merge candidates (coded in Intra TMP or IBC) are compared to planar prediction on the reconstructed template. The template cost (SATD) is used to select the best predictor among them.

For a block of size W×H, the weight for each of the five derived modes is modified if the one the above or left histogram magnitudes is twice larger than the other one. In this case, the weights are location dependent and computed based on the following:

If the above histogram is twice the left, then:

$${w}_{i} ( x , y ) = {wDimd}_{i} + {Δ}_{i} - 2 {Δ}_{i} \frac{y}{( H - 1 )} \qquad ( 9 )$$

If the left histogram is twice the above, then:

$${w}_{i} ( x , y ) = {wDimd}_{i} + {Δ}_{i} - 2 {Δ}_{i} \frac{x}{( W - 1 )} \qquad ( 10 )$$

where wDimdᵢ is the unmodified uniform weight of the DIMD, Δᵢ is pre-defined and set to 10.

Derived intra modes are included into the primary list of intra most probable modes (MPM), so the DIMD process is performed before the MPM list is constructed. The primary derived intra mode of a DIMD block is stored with a block and is used for MPM list construction of the neighboring blocks.

An occurrence-based intra coding (OBIC), derives the intra prediction modes of the current block based on the sample-wise occurrence of the intra modes in the spatial neighborhood of the block. For this, adjacent and non-adjacent spatial neighboring blocks are checked and the intra prediction modes of the blocks are collected into an occurrence histogram. Instead of Histogram of Gradients (HoGs) as in DIMD, the OBIC method uses the Histogram of Occurrences, which consists of the intra modes and their sample-wise occurrences. The occurrence values are calculated based on the number of samples that are coded in a certain intra prediction mode in that neighborhood. For example, if a uiWidth×uiHeight block is coded with an IPM mode, the occurrence of the mode in that block is calculated based on:

$$Histogram [ IPM ] += uiWidth \times uiHeight ;$$

where uiWidth and uiHeight are the width and height of a spatial neighboring block. The occurrences of the existing modes from the spatial neighborhood blocks are accumulated into the histogram.

Up to N angular modes with the highest occurrence along with the planar mode or block vector-based prediction (same as in DIMD) are selected from the histogram and used for final prediction by blending the prediction of the selected modes.

In the present disclosure, fusion for template-based intra mode derivation (TIMD) can be used in intra prediction.

In ECM, another decoder derived intra prediction mode, Fusion for template-based intra mode derivation (TIMD) is applied. For each intra prediction mode in MPMs, as well as the wide-angle modes if the above-right and/or bottom-left reference samples are available, SATD between the prediction and reconstruction samples of the template is calculated. First two intra prediction modes with the minimum SATD and one non-angular intra prediction mode (i.e., DC or Planar) with the lowest SATD cost are selected as the TIMD modes. These three TIMD modes are fused with the weights after applying position dependent intra prediction combination (PDPC) process, and such weighted intra prediction is used to code the current CU. PDPC is included in the derivation of the TIMD modes.

The conditions below are checked to determine whether the non-angular intra prediction mode is used in fusion:
the non-angular intra prediction mode is different from the two selected intra prediction modes.
costMode3<1.5*costMode1, where the costMode3 is the SATD cost of the non-angular intra prediction mode and costMode1 is the SATD cost of the first intra prediction mode.

If both of the conditions are true, three intra prediction modes are used to generate the prediction. And the weights of each intra prediction mode are computed from SATD cost based on the following:

$${weight}_{i} = \frac{sumSATD - {costMode}_{i}}{2 \times sumSATD} , sumSATD = {{\sum }_{j = 1}}^{3} {costMode}_{i}$$

Otherwise, the non-angular intra prediction mode is not used in prediction. And the costs of the two selected modes are compared with a threshold, in the test the cost factor of 2 is applied as follows:

$$costMode 2 < 2 * costMode 1.$$

If this condition is true, the fusion is applied, otherwise the only mode1 is used.

Weights of the modes are computed from their SATD costs based on the following:

$$\begin{matrix}weight 1 = costMode 2 / ( costMode 1 + costMode 2 ) \\ weight 2 = 1 - weight 1\end{matrix}$$

Besides, location-dependent sample-based fusion used in DIMD fusion process is used for the TIMD fusion but the location-dependent criterion applying to amplitudes of the selected predictors is replaced by a SATD cost-based criteria. The location-dependent criterion is determined from a ratio of the normalized SATD of the selected TIMD predictors computed in above and left template area.

In the present disclosure, spatial geometric partitioning mode (SGPM) can be used in intra prediction.

A spatial geometric partitioning mode (SGPM) method is adopted in ECM, where which makes use of geometric partitioning mode (GPM) in intra prediction. This SGPM partitions a coding block into two parts according to a partition mode and predicted each part by an intra prediction mode. Then the two predicted values of the two parts are blended to generate the final predicted value of the coding block. To efficiently express the partition and associated intra prediction information in the bit-stream, this method constructs a SGPM candidate list. FIG. 14 illustrates exemplary spatial GPM candidates, according to some embodiments of the present disclosure. As shown in FIG. 14, each candidate in the list comprises a combination of a partition mode and two intra prediction modes. The length of the SGPM candidate list is set equal to 16.

The SGPM mode is signaled by a CU-level flag. If the flag is true, for example a value of the flag equals to a first value (such as 1), an index is further signaled to indicate which SGPM candite in the SGPM candidate list is used to predict the current block.

In the present disclosure, extrapolation filter-based intra prediction (EIP) can be used in intra prediction.

An extrapolation filter-based intra prediction (EIP) mode is used in ECM. In the EIP mode, the samples in a CU are predicted from the top-left position to the bottom-right position by applying an extrapolation filter to neighboring reconstructed samples or predicted samples. The EIP mode uses a 15-tap filter for prediction based on the following:

$${pred}_{( x , y )} = {\sum }_{i = 0}^{13} ( {c}_{i} \times {t}_{( x - {offsetX}_{i} , y - {offsetY}_{i} )} ) + {c}_{14} \times {2}^{bitdepth - 1} ,$$

where pred_{(x,y)} is the predicted value at position (x, y) in the CU, cᵢ is the filter coefficient, and the t_{(x-offsetX}_{ᵢ}_{, y-offsetY}_{ᵢ}₎ is the reconstructed samples or predicted samples. Predicted sample values are clipped to the range of the reference samples instead of the full sample value range. Reference sample area used for determining the range is the same that is used when generating the filter coefficients.

The EIP filter can be derived from the neighboring reconstructed samples or be inherited from the previous EIP coded blocks.

In the present disclosure, neural network-based intra prediction (NNIP) can be used in intra prediction.

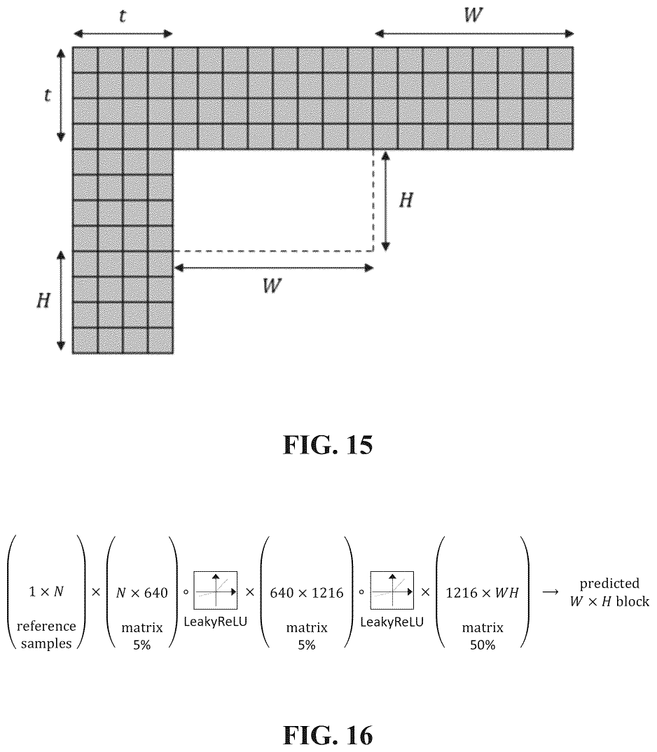

In ECM, the NNIP mode contains 6 neural networks, each predicting luma coding blocks (CBs) of a different size in {4×4, 8×4, 16×4, 8×8, 16×8, 16×16}. FIG. 15 illustrates N reference samples to predict a given W×H luma CB, according to some embodiments of the present disclosure. As shown in FIG. 15, for a given W×H luma CB, if [symbol] v{H}≥ [symbol] b{8} && \mathbit {W}\geq\mathbf{8}, t=8; else t=4. The used neural network takes the context made of N reference samples around this luma CB, to return the W\times H predicted block. For block sizes non natively supported by a model, similarly to MIP in VVC, the reference samples are transposed and/or downsampled.

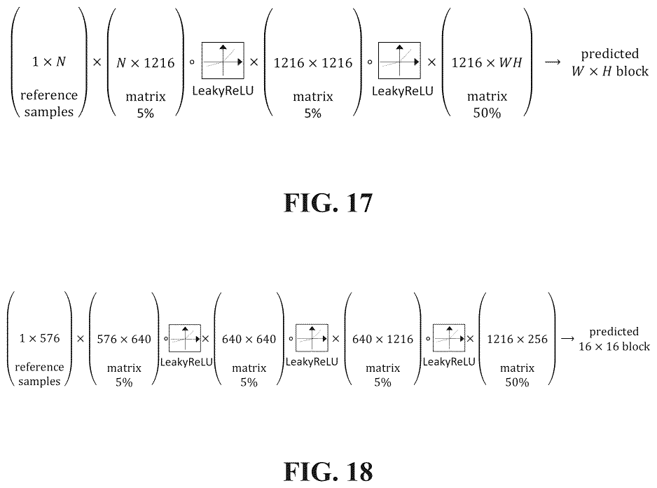

FIG. 16 to FIG. 18 illustrate some different examples of matrix multiplications and LeakyReLUs, according to some embodiments of the present disclosure. Referring to FIGS. 16-18, the number of non-zero weights for each weight matrix are displayed. A sparse vector-matrix multiplication processes chunks of 8 non-zero coefficients. The LeakyReLU used is defined as a piecewise-linear function:

$$LeakyReLU \backslash left ( x \backslash r ight ) = \backslash left \backslash \{ \backslash begin \{ matrix \} x , \backslash x \backslash geq 0 \backslash \backslash x \backslash gg 4 , \backslash x < 0 \backslash \backslash \backslash end \{ matrix \} \backslash r ight .$$

For the current W\times H luma CB whose top-left pixel is located at \left (x,\y\right) in the current luma channel, if a neural network can predict luma CB of this size and the context of this luma CB does not go out of the bounds of the current luma channel, i.e. x\geq t\ &&\y\geq t, the neural network-based intra prediction mode is signaled via a NN flag placed after the BDPCM flag and before the DIMD flag.

For a given luma CB selecting the neural network-based intra prediction mode, regarding the implicit transform mapping in MTS and LFNST/NSPT, the equivalent intra prediction mode is derived by applying DIMD to the predicted block returned by the used neural network.

For a given luma CB of size larger than 64 luma samples and selecting the neural network-based intra prediction mode, an alternative equivalent intra prediction mode is used for LFNST/NSPT. Indeed, in addition to the 1^{st} equivalent intra prediction mode obtained by applying DIMD to the predicted block, PLANAR is used as additional equivalent intra mode candidate. In this case, a CU-level flag indicating the equivalent intra mode index is signaled.

In the present disclosure, transformation for intra is also used for video coding, and multiple transform selection (MTS) is used in transform for intra.

In addition to DCT-II which has been employed in HEVC, a Multiple Transform Selection (MTS) scheme is used for residual coding both inter and intra coded blocks in VVC. Multiple selected transforms from the DCT-VIII/DST-VII are used. The newly introduced transform matrices are DST-VII and DCT-VIII. Table 1 shows the basis functions of the selected DST/DCT.

TABLE 1
Transform basis functions of DCT-II/ VIII
and DST-VII for N-point input

| Transform Type | Basis function T(j), i, j = 0, 1,..., N-1 |
|---|---|
| DCT-II | T_i\left(j\right) |
| | =\omega_0\bullet\sqrt{\frac{2}{N}}\bullet |
| | \cos{\left(\frac{\pi\bullet i\bullet\left(2j |
| | + 1\right)}{2N}\right)} |
| | where, |
| DCT-VIII | T_i(j)=\sqrt{\frac{4}{2N |
| | + 1}}\bullet\cos\funcapply{\open\frac{} |
| | \frac{\pi\bullet(2i + 1)\bullet(2j + 1)}{4N |
| | + 2}\right)} |
| DST-VII | T_i\left(j\right) |
| | =\sqrt{\frac{4}{2N |
| | + 1}}\bullet\sin{\left(\frac{\pi\bullet |
| | \left(2i + 1\right)\bullet\left(j |
| | + 1\right)}{2N + 1}\right)} |

In order to keep the orthogonality of the transform matrix, the transform matrices are quantized more accurately than the transform matrices in HEVC. To keep the intermediate values of the transformed coefficients within the 16-bit range, after horizontal and after vertical transform, all the coefficients are to have 10-bit.

In order to control MTS scheme, separate enabling flags are specified at SPS level for intra and inter, respectively. When MTS is enabled at SPS, a CU level flag is signaled to indicate whether MTS is applied or not. Here, MTS is applied only for luma. The MTS signaling is skipped when one of the below conditions is applied.
The position of the last significant coefficient for the luma TB is less than 1 (i.e., DC only)
The last significant coefficient of the luma TB is located inside the MTS zero-out region.

If MTS CU flag is equal to zero, then DCT-II is applied in both directions. However, if MTS CU flag is equal to one, then two other flags are additionally signaled to indicate the transform type for the horizontal and vertical directions, respectively. Transform and signaling mapping table as shown in Table 2. Unified the transform selection for ISP and implicit MTS is used by removing the intra-mode and block-shape dependencies. If current block is ISP mode or if the current block is intra block and both intra and inter explicit MTS is on, then only DST-VII is used for both horizontal and vertical transform cores. When it comes to transform matrix precision, 8-bit primary transform cores are used. Therefore, all the transform cores used in HEVC are kept as the same, including 4-point DCT-II and DST-VII, 8-point, 16-point and 32-point DCT-II. Also, other transform cores including 64-point DCT-II, 4-point DCT-VIII, 8-point, 16-point, 32-point DST-VII and DCT-VIII, use 8-bit primary transform cores.

TABLE 2
Transform and signaling mapping table

| MTS_ | MTS_ | MTS | Intra/inter | |
|---|---|---|---|---|
| CU_flag | Hor_flag | Ver_flag | Horizontal | Vertical |
| 0 | | | DCT-II | |
| 1 | 0 | 0 | DST-VII | DST-VII |
| | 0 | 1 | DCT-VIII | DST-VII |
| | 1 | 0 | DST-VII | DCT-VIII |
| | 1 | 1 | DCT-VIII | DCT-VIII |

To reduce the complexity of large size DCT-VII and DCT-VIII, High frequency transform coefficients are zeroed out for the DCT-VII and DCT-VIII blocks with size (width or height, or both width and height) equal to 32. Only the coefficients within the 16×16 lower-frequency region are retained.

As in HEVC, the residual of a block can be coded with transform skip mode. To avoid the redundancy of syntax coding, the transform skip flag is not signalled when the CU level MTS_CU_flag is not equal to zero. Note that implicit MTS transform is set to DCT-II when LFNST or MIP is activated for the current CU. Moreover, the implicit MTS can be still enabled when MTS is enabled for inter coded blocks.

In ECM, additional primary transforms including DCT-V, DST-IV, DST-I, and identity transform (IDT) are employed. Moreover, MTS set is made dependent on the TU size and intra mode information. For blocks predicted via Intra TMP, DIMD process is used on the prediction block to derive an intra mode that is used for transform selection. Specifically, a horizontal gradient and a vertical gradient are calculated for each predicted sample to build a HoG. Then the intra prediction mode with the largest histogram amplitude values is used to the MTS transform set.

Overall, 16 different transform unit (TU) sizes are considered, and for each TU size 5 different classes are considered depending on intra-mode information. For each class, 1, 4 or 6 different transform pairs are considered. Number of intra MTS candidates are adaptively selected (between 1, 4 and 6 MTS candidates) depending on the sum of absolute value of transform coefficients. The sum is compared against the two fixed thresholds to determine the total number of allowed MTS candidates:
1 candidate: sum<=th0
4 candidates: th0<sum<=th1
6 candidates: sum>th1

Although a total of 80 different classes are considered, some of those different classes often share exactly same transform set. So, there are 58 (less than 80) unique entries in the resultant look-up table (LUT).

For angular modes, a joint symmetry over TU shape and intra prediction is considered. A mode i (i>34) with TU shape A×B is mapped to the same class corresponding to the mode j=(68-i) with TU shape B×A. However, for each transform pair the order of the horizontal and vertical transform kernel is swapped. For example, for a 16×4 block with mode 18 (horizontal prediction) and a 4×16 block with mode 50 (vertical prediction) are mapped to the same class. However, the vertical and horizontal transform kernels are swapped. For the wide-angle modes the nearest conventional angular mode is used for the transform set determination. For example, mode 2 is used for all the modes between −2 and −14. Similarly, mode 66 is used for mode 67 to mode 80.

The additional primary transforms including DCT-V, DST-IV, DST-I and IDT are also applied to angular intra modes when the implicit intra MTS is enabled. The primary transform pair is directly inferred from the intra prediction mode and the TU size of the current block using the same LUT as the one used in explicit intra MTS.

In the present disclosure, low frequency non-separable secondary transform (LFNST) can be used in transform for intra.

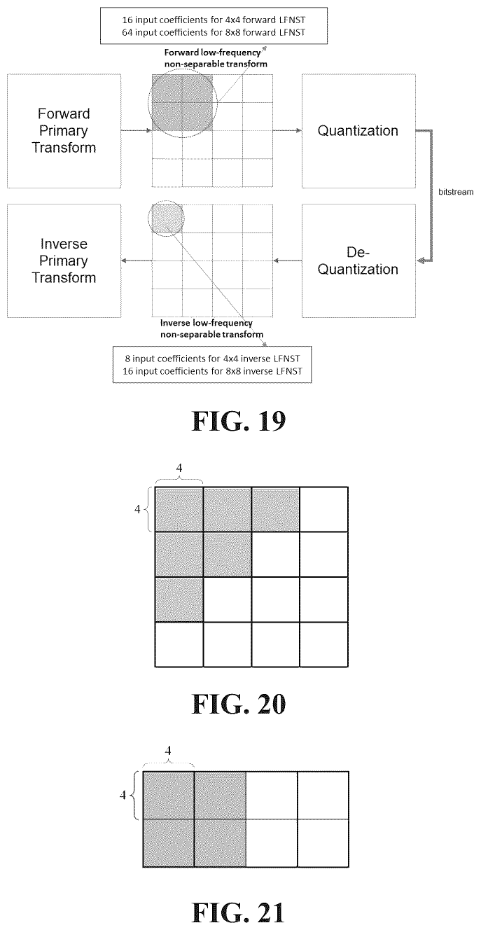

FIG. 19 illustrates an exemplary low-frequency non-separable transform (LFNST) process, according to some embodiments of the present disclosure. As shown in FIG. 19, in VVC, LFNST is applied between forward primary transform and quantization (at encoder) and between de-quantization and inverse primary transform (at decoder side). In LFNST, 4×4 non-separable transform or 8×8 non-separable transform is applied according to block size. For example, 4×4 LFNST is applied for small blocks (i.e., min (width, height)<8) and 8×8 LFNST is applied for larger blocks (i.e., min (width, height)>4).

Application of a non-separable transform, which is being used in LFNST, is described as follows using input as an example. To apply 4×4 LFNST, the 4×4 input block X:

```
X =\left[\begin{matrix}\begin{matrix}X_{00}&X_{01}\\X_{10}&X_{11}\\
  \end{matrix}&\begin{matrix}X_{02}&X_{03}\\X_{12}&X_{13}\\
  \end{matrix}\\\begin{matrix}X_{20}&X_{21}\\X_{30}&X_{31}\\
  \end{matrix}&\begin{matrix}X_{22}&X_{23}\\X_{32}&X_{33}\\
  \end{matrix}\\\end{matrix}\right]
```

is first represented as a vector \hvec {X}:

```
  \hvec{X} =\left[\begin{matrix}\begin{matrix}\begin{matrix}\begin{matrix}X_{00}&X_{01}\\\
  end{matrix}&\begin{matrix}X_{02}&X_{03}\\\end{matrix}\\\end{matrix}&\begin{matrix}\
begin{matrix}X_{10}&X_{11}\\\end{matrix}&\begin{matrix}X_{12}&X_{13}\\\end{matrix}\\\
  end{matrix}\\\end{matrix}&\begin{matrix}\begin{matrix}\begin{matrix}X_{20}&X_{21}\\\
  end{matrix}&\begin{matrix}X_{22}&X_{23}\\\end{matrix}\\\end{matrix}&\begin{matrix}\
begin{matrix}X_{30}&X_{31}\\\end{matrix}&\begin{matrix}X_{32}&X_{33}\\\end{matrix}\\\
    end{matrix}\\\end{matrix}\\\end{matrix}\right]\hat{ }T.
```

The non-separable transform is calculated as \hvec {F}=T\bullet\hvec {X}, where \hvec {F} indicates the transform coefficient vector, and Tis a 16×16 transform matrix. The 16×1 coefficient vector \hvec {F} is subsequently re-organized as 4×4 block using the scanning order for that block (horizontal, vertical or diagonal). The coefficients with smaller index will be placed with the smaller scanning index in the 4×4 coefficient block.

LFNST is based on direct matrix multiplication approach to apply non-separable transform so that it is implemented in a single pass without multiple iterations. However, the non-separable transform matrix dimension needs to be reduced to minimize computational complexity and memory space to store the transform coefficients. Reduced non-separable transform (also referred as RST) method is used in LFNST. The main idea of the reduced non-separable transform is to map an N (N is commonly equal to 64 for 8×8 non-separable secondary transform (NSST)) dimensional vector to an R dimensional vector in a different space, where N/R(R<N) is the reduction factor. Hence, instead of N×N matrix, RST matrix becomes an R×N matrix as follows:

$${T}_{R \times N} = [ \begin{matrix}{t}_{11} & {t}_{12} & {t}_{13} & … & {t}_{1 N} \\ {t}_{21} & {t}_{22} & {t}_{23} & & {t}_{2 N} \\ & ⋮ & & ⋱ & ⋮ \\ {t}_{R 1} & {t}_{R 2} & {t}_{R 3} & … & {t}_{RN}\end{matrix} ]$$

where the R rows of the transform are R bases of the N dimensional space. The inverse transform matrix for reduced transformation (RT) is the transpose of its forward transformation. For 8×8 LFNST, a reduction factor of 4 is applied, and 64×64 direct matrix, which is conventional 8×8 non-separable transform matrix size, is reduced to 16×48 direct matrix. Hence, the 48×16 inverse RST matrix is used at the decoder side to generate core (primary) transform coefficients in 8×8 top-left regions. When 16×48 matrices are applied instead of 16×64 with the same transform set configuration, each of which takes 48 input data from three 4×4 blocks in a top-left 8×8 block excluding right-bottom 4×4 block. With the help of the reduced dimension, memory usage for storing all LFNST matrices is reduced from 10 KB to 8 KB with reasonable performance drop. In order to reduce complexity, LFNST is restricted to be applicable only if all coefficients outside the first coefficient sub-group are non-significant. Hence, all primary-only transform coefficients must be zero when LFNST is applied. This allows a conditioning of the LFNST index signalling on the last-significant position and hence avoids the extra coefficient scanning in the current LFNST design, which is needed for checking for significant coefficients at specific positions only. The worst-case handling of LFNST (in terms of multiplications per pixel) restricts the non-separable transforms for 4×4 and 8×8 blocks to 8×16 and 8×48 transforms, respectively. In those cases, the last-significant scan position must be less than 8 when LFNST is applied, for other sizes less than 16. For blocks with a shape of 4×N and N×4 and N>8, the proposed restriction implies that the LFNST is now applied only once, and that to the top-left 4×4 region only. As all primary-only coefficients are zero when LFNST is applied, the number of operations needed for the primary transforms is reduced in such cases. From encoder perspective, the quantization of coefficients is remarkably simplified when LFNST transforms are tested. A rate-distortion optimized quantization must be done at maximum for the first 16 coefficients (in scan order), the remaining coefficients are enforced to be zero.

There are totally 4 transform sets and 2 non-separable transform matrices (kernels) per transform set are used in LFNST. The mapping from the intra prediction mode to the transform set is pre-defined as shown in Table 3. If one of three cross-component linear mode1 (CCLM) modes (INTRA_LT_CCLM, INTRA_T_CCLM or INTRA L CCLM) is used for the current block (81<=predModeIntra<=83), transform set 0 is selected for the current chroma block. For each transform set, the selected non-separable secondary transform candidate is further specified by the explicitly signalled LFNST index. The index is signalled in a bit-stream once per Intra CU after transform coefficients.

TABLE 3
Transform selection table

| | Tr. set |
|---|---|
| IntraPredMode | index |
| IntraPredMode < 0 | 1 |
| 0 <= IntraPredMode <= 1 | 0 |
| 2 <= IntraPredMode <= 12 | 1 |
| 13 <= IntraPredMode <= 23 | 2 |
| 24 <= IntraPredMode <= 44 | 3 |
| 45 <= IntraPredMode <= 55 | 2 |
| 56 <= IntraPredMode <= 80 | 1 |
| 81 <= IntraPredMode <= 83 | 0 |

Since LFNST is restricted to be applicable only if all coefficients outside the first coefficient sub-group are non-significant, LFNST index coding depends on the position of the last significant coefficient. In addition, the LFNST index is context coded but does not depend on intra prediction mode, and only the first bin is context coded. Furthermore, LFNST is applied for intra CU in both intra and inter slices, and for both Luma and Chroma. If a dual tree is enabled, LFNST indices for Luma and Chroma are signaled separately. For inter slice (the dual tree is disabled), a single LFNST index is signaled and used for both Luma and Chroma.

Considering that a large CU greater than 64×64 is implicitly split (TU tiling) due to the existing maximum transform size restriction (64×64), an LFNST index search could increase data buffering by four times for a certain number of decode pipeline stages. Therefore, the maximum size that LFNST is allowed is restricted to 64×64. Note that LFNST is enabled with DCT-II only. The LFNST index signaling is placed before MTS index signaling.

The use of scaling matrices for perceptual quantization is not evident that the scaling matrices that are specified for the primary matrices may be useful for LFNST coefficients. Hence, the uses of the scaling matrices for LFNST coefficients are not allowed. For single-tree partition mode, chroma LFNST is not applied.

In ECM, the LFNST design in VVC is extended as follows:
The number of LFNST sets(S) and candidates (C) are extended to S=35 and C=3, and the LFNST set (IfnstTrSetIdx) for a given intra mode (predModeIntra) is derived according to the following formula:
   For predModeIntra<2, lfnstTrSetIdx is equal to 2
   lfnstTrSetIdx=predModeIntra, for predModeIntra in [0,34]
   lfnstTrSetIdx=68-predModeIntra, for predModeIntra in [35,66]
Three different kernels, LFNST4, LFNST8, and LFNST16, are defined to indicate LFNST kernel sets, which are applied to 4×N/N×4 (N\geq4), 8×N/N×8 (N\geq8), and M×N (M, N\geq16), respectively.

The kernel dimensions are specified by:

$$( LFSNT 4 , LFNST {8}^{*} , LFNST {16}^{*} ) = ( 16 \times 16 , 32 \times 64 , 32 \times 96 ) .$$

The forward LFNST is applied to top-left low frequency region, which is called Region-Of-Interest (ROI). When LFNST is applied, primary-transformed coefficients that exist in the region other than ROI are zeroed out, which is not changed from the VVC standard.

FIG. 20 illustrates exemplary ROI for LFNST16, according to some embodiments of the present disclosure. As shown in FIG. 20, there are six 4×4 sub-blocks, which are consecutive in scan order. Since the number of input samples is 96, transform matrix for forward LFNST16 can be R×96. R is chosen to be 32 in this contribution, 32 coefficients (two 4×4 sub-blocks) are generated from forward LFNST16 accordingly, which are placed following coefficient scan order.

FIG. 21 illustrates exemplary ROI for LFNST8, according to some embodiments of the present disclosure. As shown in FIG. 21, the forward LFNST8 matrix can be R×64 and R is chosen to be 32. The generated coefficients are located in the same manner as with LFNST16.

The mapping from intra prediction modes to these sets is shown in Table 4.

TABLE 4
Mapping of intra prediction modes to LFNST set index

| Intra pred. mode | −14 | −13 | −12 | −11 | −10 | −9 | −8 | −7 | −6 | −5 | −4 | −3 | −2 | −1 | 0 |
|---|---|---|---|---|---|---|---|---|---|---|---|---|---|---|---|
| LFNST set index | 2 | 2 | 2 | 2 | 2 | 2 | 2 | 2 | 2 | 2 | 2 | 2 | 2 | 2 | 0 |

| Intra pred. mode | 1 | 2 | 3 | 4 | 5 | 6 | 7 | 8 | 9 | 10 | 11 | 12 | 13 | 14 | 15 | 16 | 17 |
|---|---|---|---|---|---|---|---|---|---|---|---|---|---|---|---|---|---|
| LFNST set index | 1 | 2 | 3 | 4 | 5 | 6 | 7 | 8 | 9 | 10 | 11 | 12 | 13 | 14 | 15 | 16 | 17 |

| Intra pred. mode | 18 | 19 | 20 | 21 | 22 | 23 | 24 | 25 | 26 | 27 | 28 | 29 | 30 | 31 | 32 | 33 |
|---|---|---|---|---|---|---|---|---|---|---|---|---|---|---|---|---|
| LFNST set index | 18 | 19 | 20 | 21 | 22 | 23 | 24 | 25 | 26 | 27 | 28 | 29 | 30 | 31 | 32 | 33 |

| Intra pred. mode | 34 | 35 | 36 | 37 | 38 | 39 | 40 | 41 | 42 | 43 | 44 | 45 | 46 | 47 | 48 | 49 |
|---|---|---|---|---|---|---|---|---|---|---|---|---|---|---|---|---|
| LFNST set index | 34 | 33 | 32 | 31 | 30 | 29 | 28 | 27 | 26 | 25 | 24 | 23 | 22 | 21 | 20 | 19 |

| Intra pred. mode | 50 | 51 | 52 | 53 | 54 | 55 | 56 | 57 | 58 | 59 | 60 | 61 | 62 | 63 | 64 | 65 |
|---|---|---|---|---|---|---|---|---|---|---|---|---|---|---|---|---|
| LFNST set index | 18 | 17 | 16 | 15 | 14 | 13 | 12 | 11 | 10 | 9 | 8 | 7 | 6 | 5 | 4 | 3 |

| Intra pred. mode | 66 | 67 | 68 | 69 | 70 | 71 | 72 | 73 | 74 | 75 | 76 | 77 | 78 | 79 | 80 |
|---|---|---|---|---|---|---|---|---|---|---|---|---|---|---|---|
| LFNST set index | 2 | 2 | 2 | 2 | 2 | 2 | 2 | 2 | 2 | 2 | 2 | 2 | 2 | 2 | 2 |

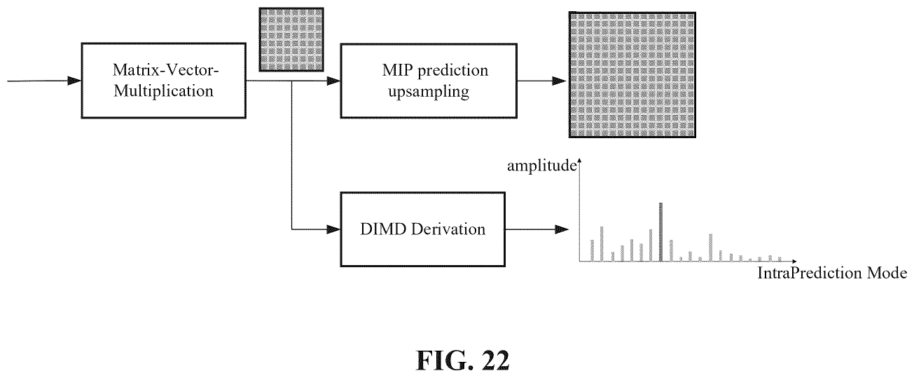

For blocks using MIP or IntraTMP prediction, the LFNST set index is derived as follows. DIMD is used to derive the intra prediction mode of the current block based on the MIP or IntraTMP predicted samples. For MIP, this is done before up sampling. Specifically, a horizontal gradient and a vertical gradient are calculated for each predicted sample to build a HoG. FIG. 22 illustrates exemplary process of using MIP prediction samples to build HOG, according to some embodiment of the present disclosure. Then the intra prediction mode with the largest histogram amplitude values is used to determine the LFNST transform set and LFNST Transpose flag.

In the present disclosure, Non-separable primary transform (NSPT) can be used in transform for intra.

The separable DCT-II plus LFNST transform combinations are replaced with NSPT for the block shapes 4×4, 4×8, 8×4 and 8×8, 4×16, 16×4, 8×16 and 16×8 in ECM.

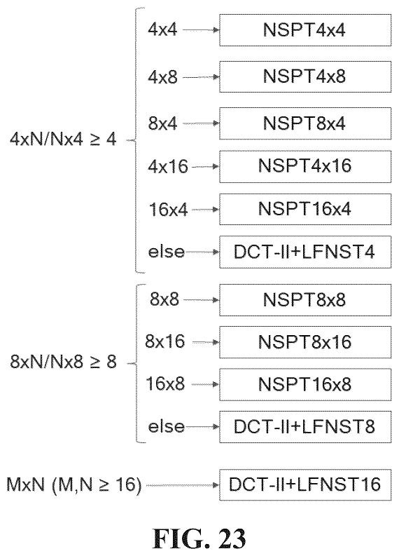

FIG. 23 illustrates an overview of proposed NSPTs among existing LFNSTs, according to some embodiments of the present disclosure. As shown in FIG. 23, the affected block sizes are summarized.

All NSPTs consist of 35 sets and 3 candidates (similar to the current LFNST). The kernels of NSPTs have the following shapes:

$$\begin{matrix}NSPT 4 \times 4 : 16 \times 16 \\ NSPT 4 \times 8 / NSPT 8 \times 4 : 32 \times 20 \\ NSPT 8 \times 8 : 64 \times 32 \\ NSPT 4 \times 16 / NSPT 16 \times 4 : 64 \times 24 \\ NSPT 8 \times 16 / NSPT 16 \times 8 : 128 \times 40 \\ NSPT 4 \times 32 / NSPT 32 \times 4 : 128 \times 20 \\ NSPT 8 \times 32 / NSPT 32 \times 8 : 256 \times 24\end{matrix}$$

Therefore, 12, 32, 40 and 88 coefficients are zeroed-out using NSPT4×8/NSPT8×4, NSPT8×8, NSPT4×16/NSPT16×4, and NSPT8×16/NSPT16×8 respectively. For NSPT4×32/NSPT32×4 and NSPT8×32/NSPT32×8, remaining 108 and 232 positions in each transform block are zeroed-out, respectively.

NSPT kernel sets are extended to three sets according to the block prediction mode types.
1. Conventional intra predicted blocks using NSPT.
2. TIMD, DIMD, EIP, MIP or SGPM using NSPT.
3. IntraTMP and inter CUs blocks using NSPT.

In the present disclosure, subblock transform (SBT) is also used for video coding.

In VVC, subblock transform (SBT) is introduced for an inter-predicted CU. In this transform mode, only a sub-part of the residual block is coded for the CU. When inter-predicted CU with cu_cbf equal to 1, cu_sbt_flag may be signaled to indicate whether the whole residual block or a sub-part of the residual block is coded. In the former case, inter MTS information is further parsed to determine the transform type of the CU. In the latter case, a part of the residual block is coded with inferred adaptive transform, and the other part of the residual block is zeroed out.

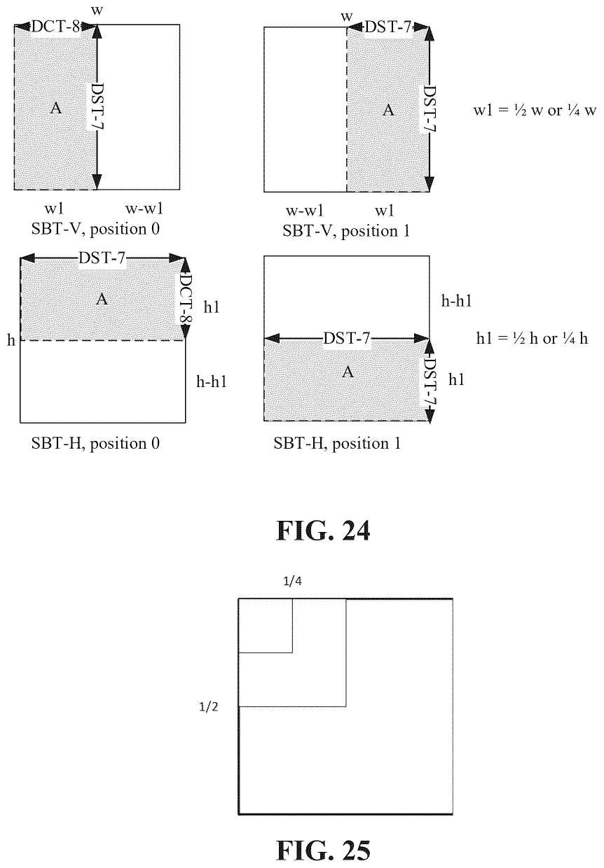

When SBT is used for an inter-coded CU, SBT type and SBT position information are signaled in the bitstream. FIG. 24 illustrates exemplary SBT positions, types and transform types, according to some embodiments of the present disclosure. As shown in FIG. 24, there are two SBT types and two SBT positions. For SBT-V (or SBT-H), the TU width (or height) may equal to half of the CU width (or height) or ¼ of the CU width (or height), resulting in 2:2 split or 1:3/3:1 split. The 2:2 split is like a binary tree (BT) split while the 1:3/3:1 split is like an asymmetric binary tree (ABT) split. In ABT splitting, only the small region contains the non-zero residual. If one dimension of a CU is less than 8 in luma samples, the 2:2 split along that dimension is disallowed. If one dimension of a CU is less than 16 in luma samples, the 1:3/3:1 split along that dimension is disallowed. There are at most 8 SBT modes for a CU.

Position-dependent transform core selection is applied on luma transform blocks in SBT-V and SBT-H (chroma TB always using DCT-II). The two positions of SBT-H and SBT-V are associated with different core transformations. More specifically, the horizontal and vertical transforms for each SBT position are specified in FIG. 22. For example, the horizontal and vertical transforms for SBT-V position 0 are DCT-VIII and DCT-VII, respectively. When one side of the residual TU is greater than 32, the transform for both dimensions is set as DCT-II. Therefore, the subblock transforms jointly specifies the TU tiling, cbf, and horizontal and vertical core transform type of a residual block.

The SBT is not applied to the CU coded with combined inter-intra mode.

In ECM, four corners are introduced to SBT. FIG. 25 illustrates corner subblocks (only top left is shown), according to some embodiments of the present disclosure. The size of the subblock can be width/2×height/2 or width/4×height/4, the former (e.g., width/2×height/2) can be applied for transform blocks 8×8 and larger, and the latter (e.g., width/4×height/4) can be applied for transform blocks 16×16 and larger.

Transform kernels are implicitly derived, DCT-VIII and DCT-VII combination is used for corner subblocks, and DST-I is used for the center.

Similar to the existing SBT, the split mode and the location of the non-zero subblock is signaled. The signaling is done if SBT mode is enabled and placed after the existing SBT modes.

According to an ECM proposal, LFNST transform is also applied, and choice of the transform is signaled for those subblocks following the adoption of LFNST transform usage for SBT.

According to an ECM proposal, an advanced SBT method is proposed. The principle of the Advanced SBT is to determine the position and the direction of a subblock partition thanks to the Inter prediction block. The possible subblock partitions are the same as the ones of SBT in the VVC specifications. However, the proposed Advanced SBT infers the position and the direction of the subblock partitioning to save some signaling.

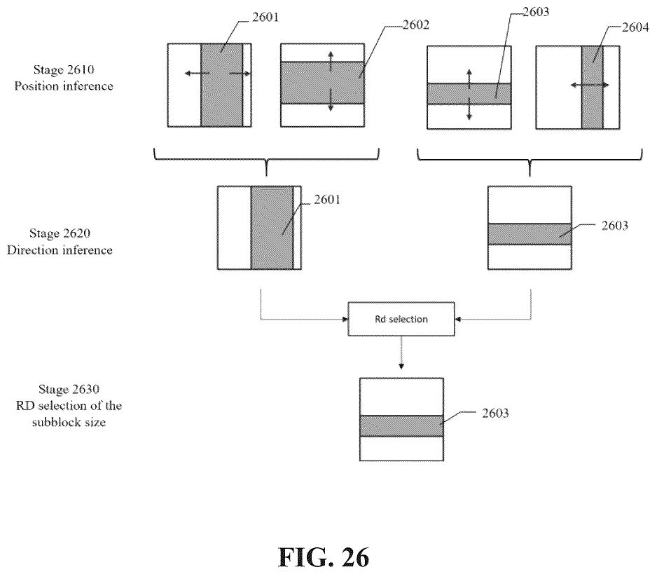

FIG. 26 illustrates general principle at encoder side for advanced SBT, according to some embodiments of the present disclosure. As shown in FIG. 26, in stage 2610, for each subblock size and direction, the encoder evaluates the best position of the transform part (grey area). The selected position is the position of the subblock which maximizes the sum of gradients obtained on the corresponding Inter predictor block. For example, subdivisions 2601 and 2602 are selected for vertical direction and horizontal direction, respectively, with width/2 or height/2. Subdivisions 2603 and 2604 are selected for horizontal direction and vertical direction, respectively, with height/4 or width/4. In stage 2620, based on the best position, the direction for each subdivision is determined. Regarding the direction (vertical or horizontal), the selected direction is the one that maximizes the sum of gradients of each best position. For example, vertical direction is selected between subdivision 2601 and subdivision 2602, and horizontal direction is selected between subdivision 2603 and subdivision 2604. Therefore, in this stage, subdivision 2601 and subdivision 2603 are selected. In stage 2630, the best subdivision is determined based on RD selection. For example, at this stage, subdivision 2603 is finally determined between subdivision 2601 and subdivision 2603. Eventually the encoder determines the best subdivision.

Compared to the SBT mode of VVC, only the subblock subdivision is signaled if the enabled flag of the proposed method is true, for example a value of the enabled flag equals to a first value (such as 1). The proposed Advanced SBT is signaled at TU level and it is also allowed for SBT TU with residual to obtain a smaller subblock residual. The enabled flag and the subdivision flags are CABAC-coded and the context probability increment value depends on the use of SBT.

The following problems are observed in the above-described video coding technology.

Statistically, energy of inter prediction residual increases from the center of prediction block towards its boundaries. In addition, in many cases, the inter-prediction residuals are localized at one side of the block, rather than being distributed around all block boundaries. Inspired by this statistic, SBT method is developed that uses a smaller transform block to capture the localized residuals and further considering the unique distribution of inter prediction residual.

Although the distribution of intra prediction residuals is different from that of inter prediction residuals, for certain intra prediction residuals, the SBT mode may be suitable. Using smaller transform blocks to capture local residuals may still be beneficial for intra prediction residual blocks.

The present disclosure provides solutions to one or more of the above-described problems.

Consistent with the disclosed embodiments, it is proposed to apply subblock transform (SBT) for intra prediction coded blocks.

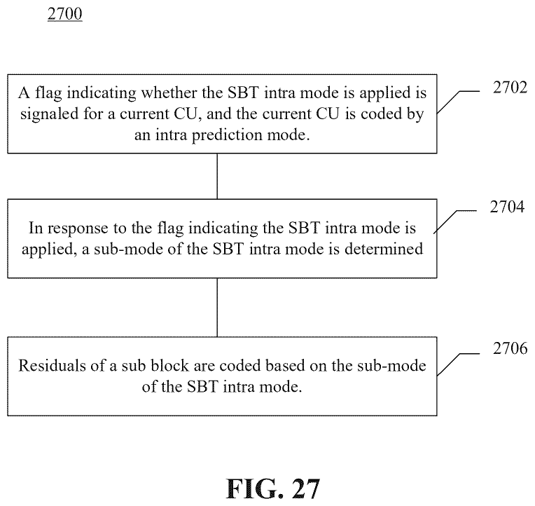

In some embodiments, for an intra predicted CU, only the residual in a sub-block of the CU is coded. This method can be represented as SBT intra mode in the present disclosure. FIG. 27 is a flowchart of an exemplary method of a SBT intra mode, according to some embodiments of the present disclosure. Method 2700 can be performed by an encoder (e.g., by process 200A of FIG. 2A or 200B of FIG. 2B) or performed by one or more software or hardware components of an apparatus (e.g., apparatus 400 of FIG. 4). For example, a processor (e.g., processor 402 of FIG. 4) can perform method 2700. In some embodiments, method 2700 can be implemented by a computer program product, embodied in a computer-readable medium, including computer-executable instructions, such as program code, executed by computers (e.g., apparatus 400 of FIG. 4). Referring to FIG. 27, method 2700 may include the following steps 2702 to 2706.

At step 2702, a flag indicating whether the SBT intra mode is applied is signaled for a current CU. The current CU is coded by an intra prediction mode. The flag indicates whether the whole residual block of the CU or a sub-block of the residual block of the CU is coded. If the flag indicates that the SBT intra mode is applied to the CU, a part of the residual block is coded with inferred adaptive transform kernel and the other part of the residual block is zeroed out. If the flag indicates that the SBT intra mode is not applied to the CU, the whole residual block of the CU is coded.

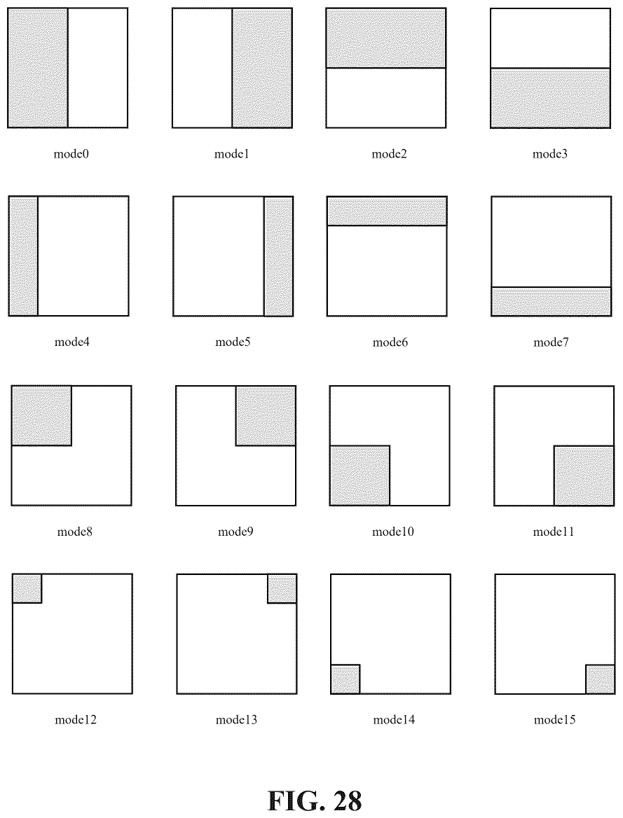

At step 2704, in response to the flag indicating the SBT intra mode is applied, a sub-mode of the SBT intra mode is determined. In some embodiments, the sub-mode is signaled in the bitstream. In some embodiments, the sub-mode is implicitly derived. FIG. 28 illustrates exemplary modes for SBT intra mode, according to some embodiments of the present disclosure. As shown in FIG. 28, there are 16 sub-modes supported for SBT intra mode, indicating different coded sub-blocks, where only the residuals in the grey areas (i.e., a sub-block determined by the sub-mode) are coded. For CUs with different sizes, the enabled sub-modes of SBT intra mode may be different. For example, the width and height of a coded sub-block should be equal to or greater than a certain threshold (e.g. 4), so that a small number of SBT intra sub-modes can be supported for smaller CUs. In some embodiments, the sub-mode can be signaled by an index.

At step 2706, residuals of a sub block are coded based on the sub-mode of the SBT intra mode.

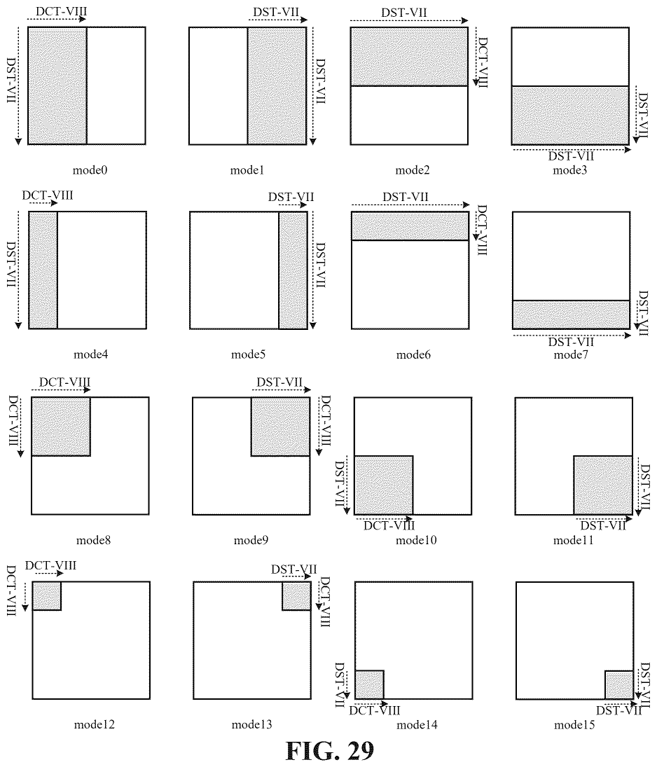

FIG. 29 illustrates exemplary transform kernel for each sub-mode of SBT intra mode, according to some embodiments of the present disclosure. If SBT intra mode is used for a CU, the current CU will be divided into TUs according the selected SBT intra sub-mode and only one of the TUs is coded, the TU is the sub-block at the grey area in FIG. 28.

Consistent with the disclosed embodiments, the SBT intra mode can be applied to different intra modes.

In some embodiments, the SBT intra mode is applied to blocks coded by conventional intra prediction modes (i.e., planar mode, DC mode, and angular modes).

In some embodiments, the SBT intra mode is applied to blocks coded by a subset of the conventional intra prediction modes.

In some embodiments, the SBT intra mode is applied to the conventional intra prediction modes in the primary MPM list.

In some embodiments, the SBT intra mode is applied to the conventional intra prediction modes in the primary MPM list and the secondary MPM list.

In some embodiments, the SBT intra mode is applied to the planar mode (index 0), DC mode (index 1), horizontal mode (index 18), and vertical mode (index 50).

In some embodiments, the SBT intra mode is applied to the planar mode (index 0), DC mode (index 1), horizontal mode (index 18), vertical mode (index 50), and two diagonal modes (index 2 and index 66).

In some embodiments, the SBT intra mode is applied to the conventional intra prediction modes derived by a DIMD liked method. For example, a histogram of gradients (HoG) is built based on the predicted samples within the current CU, and the first M conventional intra prediction modes with the largest amplitudes in the HoG can apply SBT intra mode. The value of M can be any positive integer, for example M=4.

In some embodiments, whether to apply the SBT intra mode to conventional intra prediction modes is determined by the block size. For different block sizes, the SBT intra mode is applied to different conventional intra prediction modes. For example, whether a width is greater than a height of the current CU is determined. When the width is greater than the height of the current CU, the SBT intra mode is applied to the conventional intra prediction modes close to the horizontal mode. When the width is less than or equal to the height of the current CU, the SBT intra mode is applied to the conventional intra prediction modes close to the vertical mode. In another example, whether an area of the current CU is greater than a threshold is determined. When the area of the current CU is greater than the threshold, the SBT intra mode is applied to the DC mode. When the area of the current CU is less than or equal to the threshold, the SBT intra mode is not applied to the DC mode. For example, the threshold can be 4096.

In some embodiments, whether to apply the SBT intra mode to conventional intra prediction modes is determined by the selected sub-mode of the SBT intra mode. Different SBT intra sub-modes can be applied to different conventional intra prediction modes. For example, for a SBT intra sub-mode, a HoG is built based on the predicted samples within the coded TU. Conventional intra prediction modes are sorted in a descending order based on amplitudes in the HoG. Then, the SBT intra sub-mode is applied to the first M conventional intra prediction modes with the largest amplitudes in the HoG. In some embodiments, an index is further signaled in the bitstream to indicate which candidate in a candidate list is selected. The candidate list is built based on the HoG analysis, and for different CUs and different SBT intra sub-modes, the candidate list can be different.

In some embodiments, the SBT intra mode is applied to CUs predicted by one or some of the following intra prediction mode: conventional intra prediction mode, MRL mode, ISP mode, MIP mode, IBC mode, intra TMP mode, DIMD mode, TIMD mode, SGPM mode, EIP mode, and NN intra mode.

In some embodiments, the SBT intra mode is applied to CUs predicted by the conventional intra prediction mode, IBC mode, and intra TMP mode.

In some embodiments, the SBT intra mode is applied to CUs predicted by IBC mode and intra TMP mode.

Consistent with the disclosed embodiments, whether to apply the SBT intra mode to a CU is determined based on a block size of the CU.

In some embodiments, a block size of a CU is determined. When the block size (e.g., area) of the CU is greater than a first threshold and less than a second threshold, the SBT intra mode can be applied to the CU. For example, the first threshold can be equal to 16 and the second threshold can be equal to 4096.

In some embodiments, whether a width being equal to a height of a CU is determined. When the width is not equal to the heigh, the SBT intra mode can be applied to the CU.

Consistent with the disclosed embodiments, SBT intra mode is applied with sub-modes.

In some embodiments, all the 16 SBT intra sub-modes as shown in FIG. 28 are enabled.

In some embodiments, only a subset of the 16 SBT intra sub-modes as shown in FIG. 28 are enabled. In one example, only the first 8 SBT (mode0 to mode7) intra sub-modes as shown in FIG. 28 are enabled. In another example, only the first 8 SBT intra sub-modes (model to mode7), mode11, and mode15 as shown in FIG. 28 are enabled. As another example, only the mode1, mode3, mode5, mod7, mode11, and mode15 as shown in FIG. 28 are enabled. As another example, only the mode1, mod3, mode 5, and mode7 as shown in FIG. 28 are enabled. As another example, only the first 12 modes (mode0 to model1) as shown in FIG. 28 are enabled.

In some embodiments, the enabled SBT intra sub-modes (i.e., a candidate list) are determined based on the block size of the current CU. In some embodiments, the enabled SBT intra sub-modes follow the restriction of the size of the coded sub-block, consistent with the descriptions of FIG. 24 and FIG. 25. Therefore, the SBT intra sub-modes selected in the above examples are the most supported modes. For CUs of different sizes, the supported modes may only be part of the modes presented in the above examples. Consistent with FIG. 28, for example, when only the first 8 SBT intra sub-modes (i.e., mode0 to mode7) are enabled. For blocks whose width is less than 8, only 4 SBT intra sub-modes (mode2, mode3, mode6, and mode7) can be supported. For blocks whose height is less than 8, only 4 SBT intra sub-modes (mode0, mode1, mode4, and mode5) can be supported. For blocks whose width is equal to 8, only 6 SBT intra sub-modes (mode0, mode1, mode2, mode3, mode6, and mode7) can be supported. For blocks whose height is equal to 8, only 6 SBT intra sub-modes (mode0, mode1, mode2, mode3, mode4 and mode5) can be supported. For other blocks, the first 8 SBT intra sub-modes are supported.

In some embodiments, the enabled SBT intra sub-modes (i.e., a candidate list) are determined based on the block shape of the current CU. For example, if the width of a block is greater than the height of the block, SBT-H modes (mode2, mode3, mode6, and mode7) as shown in FIG. 28 are not supported. If the width of a block is less than the height of the block, SBT-V modes (mode0, mode1, mode4, and mode5) as shown in FIG. 28 are not supported.

In some embodiments, the enabled SBT intra sub-modes are determined based on the intra prediction mode of the current CU. For example, an intra prediction mode of the current CU is determined. When the intra prediction mode is an NN intra mode, a first group of sub-modes is enabled. When the intra prediction mode is a conventional intra prediction mode, a second group of sub-modes is enabled. In some embodiments, the first group of sub-modes includes the mode1, mode3, mode5, and mode7 as shown in FIG. 28, and the second group of sub-modes includes all the 16 SBT intra sub-modes as shown in FIG. 28.

In some embodiments, if the SBT intra is applied to a conventional intra mode predicted CU, the enabled SBT intra sub-modes (i.e., a candidate list) are determined based on the conventional intra mode. For example, if the conventional mode is close to the horizontal mode (e.g., a distance between an index of the conventional mode and vertical mode (index 50) is less than a distance between the index of the conventional mode and horizontal mode (index 18)), the SBT intra sub-mode 1 and sub-mode 5 as shown in FIG. 28 are enabled; if the conventional mode is close to the vertical mode, the SBT intra sub-mode 3 and sub-mode 7 as shown in FIG. 28 are enabled.

In some embodiments, if the SBT intra mode is applied to a non-conventional intra mode predicted CU, the enabled SBT intra sub-modes (i.e., a candidate list) are determined based on a derived conventional intra mode. In some embodiments, the derived conventional intra mode can be determined based on a HoG analysis of the prediction samples of the current CU. In some embodiments, if the current CU is coded by a fusion method and at least one conventional intra mode participates in the prediction (e.g., DIMD mode, TIMD mode, and SGPM mode), the enabled SBT intra sub-modes are determined based on one of the participated conventional intra mode that is selected as the derived conventional intra mode.

In some embodiments, the enabled SBT intra sub-modes (i.e., a candidate list) are determined based on the block size and the intra prediction mode of the current CU.

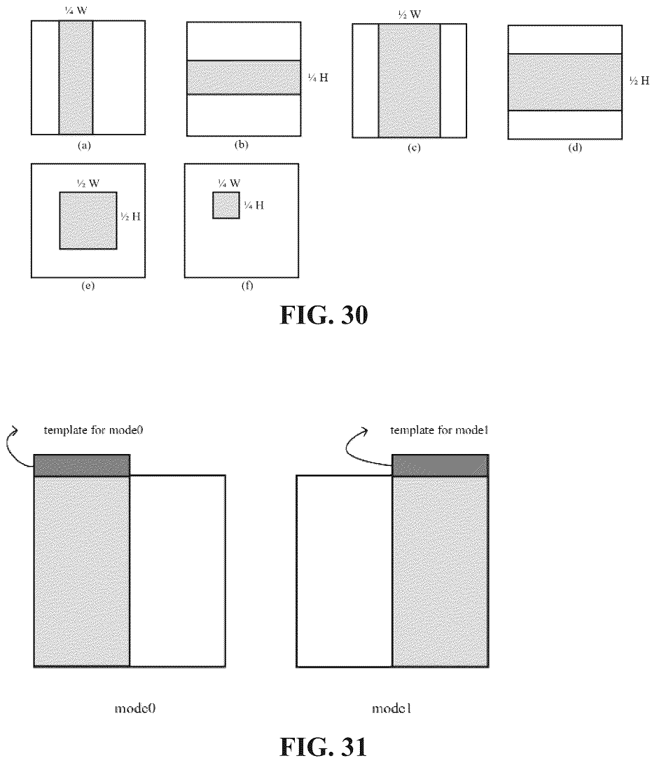

In some embodiments, more SBT intra sub-modes can be enabled for SBT intra mode. FIG. 30 illustrates exemplary examples of more SBT intra sub-modes, according to some embodiments of the present disclosure. For example, one or more of the SBT intra sub-modes as shown in FIG. 30 can be enabled. Referring to FIG. 30, the coded sub-block (the grey area) can be at any position within the current CU. The supported size of the coded sub-block can be ¼ W×H, ¼H×W, ½W×H, ½H×W, ½ W×½H, or ¼W×¼H, where W and H are the width and the height of the current CU, respectively. It can be seen that the 16 modes in FIG. 28 are some special cases in FIG. 30.

The SBT intra sub-modes can be divided into three dimensions: the shape of the sub-block, the position of the sub-block, and the direction of the sub-block. For example, for the 16 modes in FIG. 28, mode0 and mode1 have the same shape and the same direction but different positions; mode0 and mode2 have the same shape and the same position but different directions; mode0 and mode4 have the same position and the same direction but different shapes.

In some embodiments, an implicit derived method is applied to determine the used SBT intra sub-mode or one or some of the three dimensions of the used SBT intra sub-mode of the current CU. The implicit derived method can be based on the information of the samples within current CU or the samples adjacent to the current CU, which will be described in detail later.

In some embodiments, the position of the SBT intra sub-mode is derived implicitly. An explicit syntax (for example, a flag or an index) indicating both shape and direction is signaled in the bitstream. For example, since mode0 and mode1 have the same shape and direction, the shape and direction can be determined by the syntax. In this case, an explicit syntax indicating one of the mode0 and mode1 in FIG. 28 being used for the current CU is signaled. As the positions of mode0 and mode1 are different, the position can be implicitly derived. Then an implicit method is used to determine which of the mode1 and mode2 is selected. In another example, an explicit syntax signaled in the bitstream indicates that the shape and direction of (c) in FIG. 30 is used, then an implicit method is used to determine the position.

In some embodiments, both the position and the direction of the SBT intra sub-mode are derived implicitly. An explicit syntax indicating a shape is signaled in the bitstream. For example, an explicit syntax indicating one of the mode0, mode1, mode2, and mode3 in FIG. 28 being used for the current CU is signaled. These modes have the same shape, so the shape can be determined by the syntax. Then an implicit method is used to determine which mode of these 4 modes is selected (i.e., the direction and position are implicitly derived). In another example, an explicit syntax signaled in the bitstream indicates that the shape of (c) and (d) in FIG. 30 is used, then an implicit method is used to determine the direction and position.

In some embodiments, the implicit derived method is based on the gradient information of the predicted values of the sample within the current CU. In some embodiments, the position and direction of the sub-mode is implicitly derived. An explicit syntax (e.g., a flag or an index) indicating a shape of a group of sub-modes being used for the current CU is signaled in the bitstream. For example, the group of sub-modes may include mode0, mode1, mode2, and mode3 in FIG. 28. Then a horizontal gradient and a vertical gradient of the predicted values for each sample in the coded sub-block in each sub-mode of the group of sub-modes are calculated by Sobel filter. Finally, the SBT intra sub-mode that has the maximum sum of gradients of the samples in the coded sub-block from the group of sub-modes is selected. In some embodiments, the position of the sub-mode is implicitly derived. An explicit syntax indicating both shape and direction being used for the current CU is signaled in the bitstream. For example, an explicit syntax indicating that the shape and direction of (c) and (d) in FIG. 30 being used is signaled. Then a horizontal gradient and a vertical gradient of the predicted values for each sample in the current CU are calculated by Sobel filter. Finally, the sub-block that has the maximum sum of gradients of the samples in the coded sub-block is selected to be the SBT intra sub-mode for the current block, and the sub-block is to be coded.

In some embodiments, the implicit derived method is based on the gradient information of the reconstructed values of the sample adjacent to the current CU. In some embodiments, an explicit syntax (e.g., a flag or an index) indicating a shape and a direction of a group of sub-modes being used for the current CU is signaled in the bitstream. For example, the group of sub-modes include mode0 and mode1 in FIG. 28. Then a horizontal gradient and a vertical gradient of the reconstructed values for each sample in the templates of the coded sub-block in each sub-mode of the group of sub-modes (e.g., mode0 and mode1) are calculated by Sobel filter. FIG. 31 illustrates an exemplary example of the template for different SBT intra sub-modes, according to some embodiments of the present disclosure. As shown in FIG. 31, the templates for the two SBT intra sub-modes are the adjacent samples to the coded sub-block. Finally, the SBT intra sub-mode (e.g., mode0 or mode1) that has the maximum sum of gradients of the samples in the coded sub-block from the group of sub-modes is selected.

In some embodiments, the implicit derived method is based on the template cost. For example, an explicit syntax signaled in the bitstream indicating one of a group of sub-modes being used for the current CU is signaled in the bitstream. For example, the group of sub-modes may include mode0 and mode1 in FIG. 28. Then the templates of each sub-mode in the group of sub-modes (e.g., mode0 and mode1) are predicted by the intra prediction mode of the current CU. The templates for the two SBT intra sub-modes are the adjacent samples to the coded sub-block as shown in FIG. 31. A template cost can be calculated by SAD or SATD values between reconstructed values and predicted values of the samples in the template. Finally, the SBT intra sub-mode (e.g., mode0 or mode1) that has smaller template cost from the group of sub-modes is selected.

In some embodiments, whether the implicit SBT intra sub-mode derivation method is used or not is determined based on the prediction mode of the current CU. In some embodiments, if the intra TMP or IBC mode is used to predict the current block, the implicit SBT intra sub-mode derivation method is used; otherwise, the implicit SBT intra sub-mode derivation method is not used. In some embodiments, if the intra TMP is used to predict the current block, the implicit SBT intra sub-mode derivation method is used; otherwise, the implicit SBT intra sub-mode derivation method is not used. In some embodiments, if the conventional intra prediction mode is used to predict the current block, the implicit SBT intra sub-mode derivation method is used; otherwise, the implicit SBT intra sub-mode derivation method is not used.

Consistent with the disclosed embodiments, transform kernel can be used for each SBT intra sub-mode.

In some embodiments, the transform kernels for SBT intra mode are inferred by the SBT intra sub-mode. In some embodiments, the transform kernel for each SBT intra sub-mode is as shown in FIG. 29. In some embodiments, the transform kernel for SBT intra mode is inferred based on the position of the coded sub-block. For example, for SBT intra sub-mode as (a) in FIG. 30, if the position of the coded sub-block is close to the left boundary of the current CU (i.e., a distance between a center of the position of the coded sub-block and the left boundary is less than a distance between the center of the position of the coded sub-block and the right boundary), DCT-VIII is used for horizontal transform and DST-VII is used for vertical transform; if the position of the coded sub-block is close to the right boundary or in the middle of the current CU (i.e., a distance between a center of the position of the coded sub-block and the right boundary is less than or equal to a distance between the center of the position of the coded sub-block and the left boundary), DST-VII is used for both horizontal transform and vertical transform.

In some embodiments, the transform kernels for SBT intra mode are determined by the intra prediction mode of the current CU.

In some embodiments, for intra TMP mode predicted CU, the transform kernels as shown in FIG. 29 are used. For conventional mode predicted CU, different transform kernels are used.

In some embodiments, the supported transform kernels for SBT intra mode is determined by a conventional intra prediction mode. For example, for a conventional intra prediction mode that is close to horizontal mode, DCT-VII is used for horizontal transformation of the coded sub-block; for a conventional intra prediction mode that is close to vertical mode, DCT-VII is used for vertical transformation of the coded sub-block. If the current CU is predicted by a conventional intra prediction mode, then the conventional intra prediction mode is used for transforming kernel determination; otherwise, a conventional intra prediction mode is derived for transform kernel determination.

In some embodiments, the transform kernels for SBT intra mode are determined by the size of the current CU. For example, the transform kernels for SBT intra mode are determined according to the LUT in implicit MTS by the size of the current CU.

In some embodiments, the transform kernels for SBT intra mode are determined by the size of the coded sub-block. For example, the transform kernels for SBT intra mode are determined according to the LUT in implicit MTS by the size of the coded sub-block.

In some embodiments, an explicit method is used to signal the transform kernels for SBT intra mode in the bitstream. In some embodiments, for each direction (horizontal and vertical), a flag is signaled in the bitstream to indicate which of the two transform kernels DCT-VIII and DST-VII is used. In some embodiments, for each direction (horizontal and vertical), a syntax (e.g., a flag, an index, or a parameter) is signaled in the bitstream to indicate which of the three transform kernels DCT-VIII, DST-VII and DCT-II is used. In some embodiments, for each direction (horizontal and vertical), a syntax (e.g., a flag, an index, or a parameter) is signaled in the bitstream to indicate which of the following transform kernels is used: DCT-VIII, DST-VII, DCT-II, DCT-V and DST-I.

Consistent with the disclosed embodiments, LFNST/NSPT can be used for SBT intra mode.

In some embodiments, the LFNST and NSPT are not applied to the CUs that use SBT intra mode.

In some embodiments, a flag is signaled to indicate whether LFNST is applied to the coded sub-block of a CU that uses SBT intra mode.

In some embodiments, a flag is signaled to indicate whether LFNST or NSPT is applied to the coded sub-block of a CU that uses SBT intra mode. The determination of applying LFNST or NSPT is based on the size of the coded sub-block. In some embodiments, for a coded sub-block having a small size (for example, block sizes of 4×4, 4×8, 8×4, 8×8, 4×16, 16×4, 8×16, or 16×8), the NSPT is applied.

In some embodiments, if SBT intra mode is used for a CU, then DCT-II with NSPT transform is applied to the coded sub-block.

Consistent with the disclosed embodiments, a signaling method is also proposed.

In some embodiments, an enable flag of SBT intra mode is signaled before the tu_cbf_flag. The tu_cbf flag indicates whether there is non-zero residual in a TU. If the enable flag is true, for example a value of the enable flag equals to a first value (such as 1), a tu_cbf_flag does not need to be signaled in the bitstream, i.e., the signaling of tu_cbf_flag is skipped. If the tu_cbf_flag is not signaled, for the coded TU in a SBT intra mode coded CU, the tu_cbf_flag is inferred to be true, for example a value of tu_cbf_flag is inferred to be a first value (such as 1), while for the non-coded TU in a SBT intra mode coded CU, the tu_cbf_flag is inferred to be false, for example the value of tu_cbf_flag is inferred to be a second value (such as 0).

In some embodiments, the enable flag of SBT intra mode is signaled after the tu_cbf_flag, where the tu_cbf_flag indicates whether there is non-zero residual in the current CU. If the tu_cbf_flag is true, for example a value of the tu_cbf_flag equals to the first value (such as 1), the enable flag of SBT intra mode is signaled in the bitstream. If the tu_cbf_flag is false, for example the value of the tu_cbf_flag equals to the second value (such as 0), the enable flag of SBT intra mode is not signaled in the bitstream and is inferred to be false, for example the enable flag is inferred to be a second value (such as 0), i.e., the signaling of the enabled flag of SBT intra mode is skipped.

In some embodiments, whether the enable flag of SBT intra mode is signaled is determined based on the tu_cbf flags of the neighbouring TUs. For example, if both tu_cbf_flags of above and left neighboring TUs are false, for example, values for the tu_cbf flags equal to a second value (such as 0), the enable flag of SBT intra mode is not signaled and is inferred to be false, for example, a value of the enable flag of SBT intra mode is inferred to be a second value (such as 0).

Consistent with the disclosed embodiments, the SBT intra mode can also be applied to chroma components.

In some embodiments, whether the SBT intra mode is applied for luma component or chroma component is based on a partition mode. In some embodiments, whether the SBT intra mode is applied to chroma component is determined based on whether a single tree or a dual tree is used for luma and chroma partition. For example, when a value the partition mode is a dual tree, the SBT intra mode is applied for the luma component. When the value the partition mode is a single tree, the SBT intra mode is applied for luma component and chroma components.

The embodiments described in the present disclosure can be freely combined.

In some embodiments, a non-transitory computer readable medium storing a bitstream is provided. The bitstream is generated by receiving a video sequence and encoding the video sequence to generate coded information included in the bitstream. The bitstream can be transmitted to a decoder for decoding. The video sequence is encoded by the above-described methods.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

The embodiments may further be described using the following clauses:

1. A method for encoding a video sequence, the method comprising:
receiving a video sequence; and
encoding the video sequence by:
encoding a flag indicating whether a subblock transform (SBT) intra mode is applied for a current coding unit (CU), wherein the current CU is coded in an intra prediction mode;
in response to the flag indicating the SBT intra mode is applied, determining a sub-mode of the SBT intra mode; and
encoding residuals of a sub-block based on the sub-mode.

2. The method according to clause 1, wherein encoding the residuals of a sub-block based on the sub-mode further comprises:
encoding the residuals of sub-blocks with a transform kernel based on the sub-mode, wherein the transform kernel is inferred from the sub-mode.

3. The method according to clause 1, wherein whether to encode the flag is further determined by a block size of the current CU.

4. The method according to clause 3, wherein the encoding further comprises:
determining whether a width is greater than a height of the current CU;
in response to the width being greater than the height of the current CU, determining whether the intra prediction mode is a conventional intra prediction mode close to a horizontal mode; and
in response to the intra prediction mode being a conventional intra prediction mode close to the horizontal mode, applying the SBT intra mode for the current CU.

5. The method according to clause 3, wherein the encoding further comprises:
determining whether an area of the current CU is greater than a threshold;
in response to the area being greater than the threshold, determining whether the intra prediction mode is a DC mode; and
in response to the intra prediction mode being the DC mode, applying the SBT intra mode for the current CU.

6. The method according to clause 3, wherein the encoding further comprises:
determining whether an area of the current CU is greater than a first threshold and less than a second threshold; and
in response to the area of the current CU is greater than the first threshold and less than the second threshold, applying the SBT intra mode for the current CU.

7. The method according to clause 3, wherein the encoding further comprises:
determining whether a width of is equal to a height of the current CU; and
in response to the width of being not equal to the height of the current CU, applying the SBT intra mode for the current CU.

8. The method according to clause 1, wherein the sub-mode is selected from a set of sub-modes.

9. The method according to clause 8, wherein the encoding further comprises:
constructing a candidate list of sub-modes for the current CU.

10. The method according to clause 9, wherein the candidate list for a conventional intra prediction mode is constructed based on histogram of gradients (HoGs).

11. The method according to clause 9, wherein the candidate list is constructed based on a block size of the current CU.

12. The method according to clause 9, wherein the candidate list is constructed based on a block shape of the current CU.

13. The method according to clause 9, wherein the candidate list is constructed based on an intra prediction mode.

14. The method according to clause 13, wherein
in response to the intra prediction mode is a neural network-based intra prediction (NNIP) mode, the candidate list comprises a first group of sub-modes; and
in response to the intra prediction mode is a conventional intra prediction mode, the candidate list comprises a second group of sub-modes.

15. The method according to clause 13, wherein
in response to the intra prediction mode is a non-conventional intra prediction mode, the candidate list is constructed based on a derived conventional intra mode.

16. The method according to clause 8, wherein the sub-modes are divided into three dimensions including a shape of the sub-block, a position of the sub-block, a direction of the sub-block.

17. The method according to clause 16, wherein a position of the sub-mode is implicitly derived; or a position and a direction of the sub-mode is implicitly derived.

18. The method according to clause 17, wherein the implicit derivation is based on information of predicted values of samples within the current CU.

19. The method according to clause 18, wherein the position of the sub-mode is implicitly derived, and determining the sub-mode of the SBT intra mode further comprises:
encoding a syntax indicating a shape of a group of sub-modes;
calculating a horizontal gradient and a vertical gradient of predicted values for each sample in a coded sub-block in each sub-mode of the group of sub-modes; and
selecting a sub-mode that has the maximum sum of gradients of the samples in the coded sub-block from the group of sub-modes to be the determined sub-mode.

20. The method according to clause 18, wherein the position and the direction of the sub-mode are implicitly derived, and determining the sub-mode of the SBT intra mode further comprises:
encoding a syntax indicating both shape and direction for the sub-mode;
calculating a horizontal gradient and a vertical gradient of predicted values for each sample in a coded sub-block; and
selecting a sub-block that has the maximum sum of gradients of the samples in the coded sub-block to be the determined sub-mode.

21. The method according to clause 17, wherein the implicit derivation is based on gradient information of reconstructed values of sample adjacent to the current CU.

22. The method according to clause 17, wherein the implicit derivation is based on template cost.

23. The method according to clause 17, wherein whether to apply the implicit derivation is determined based on the intra prediction mode of the current CU.

24. The method according to clause 2, wherein the transform kernel is determined based on a position of a coded sub-block.

25. The method according to clause 2, wherein the transform kernel is determined based on the intra prediction mode.

26. The method according to clause 1, wherein in response to the flag indicating the SBT intra mode is applied, a low-frequency non-separable transform (LFNST) and a non-separable primary transform (NSPT) are not applied to the current CU.

27. The method according to clause 1, wherein the encoding further comprises:
encoding a second flag indicting whether to apply a low-frequency non-separable transform (LFNST) and to a coded sub-block.

28. The method according to clause 1, wherein the flag indicating whether the SBT intra mode is applied for the current CU is a first flag, and the first flag is encoded before a second flag, wherein the second flag indicates whether there is non-zero residual in a transform unit.

29. The method according to clause 28, wherein the encoding further comprises:
in response to a value the first flag being a first value, skipping encoding the second flag;
inferring a value of the second flag to be the first value for a coded transform unit; and
inferring the value of the second flag to be a second value for a non-coded transform unit.

30. The method according to clause 1, wherein the flag indicating whether the SBT intra mode is applied for the current CU is a first flag, and the first flag is encoded after a second flag, wherein the second flag indicates whether there is non-zero residual in the current CU.

31. The method according to clause 30, wherein the encoding further comprises: in response to the second flag being a first value, encoding the first flag.

32. The method according to clause 1, wherein the SBT intra mode is applied for at least one of luma component or chroma components based on a partition mode, and the encoding further comprises:
in response to a value the partition mode is a dual tree, the SBT intra mode is applied for luma component; or
in response to a value the partition mode is a single tree, the SBT intra mode is applied for luma component and chroma components.

33. The method according to clause 1, further comprises:
storing a bitstream that is generated based on the encoding.

34. A method for decoding a bitstream, the method comprising:
receiving a bitstream; and
decoding the bitstream to form/generate/output a video sequence, the decoding comprising:
   decoding a flag indicating whether a subblock transform (SBT) intra mode is applied for a current coding unit (CU), wherein the current CU is coded in an intra prediction mode;
   in response to the flag indicating the SBT intra mode is applied, determining a sub-mode of the SBT intra mode; and
   decoding residuals of a sub-block based on the sub-mode.

35. The method according to clause 34, wherein decoding the residuals of a sub-block based on the sub-mode further comprises:
decoding the residuals of sub-blocks with a transform kernel based on the sub-mode, wherein the transform kernel is inferred from the sub-mode.

36. The method according to clause 34, wherein whether to decode the flag is further determined by a block size of the current CU.

37. The method according to clause 36, wherein the decoding further comprises:
determining whether a width is greater than a height of the current CU;
in response to the width being greater than the height of the current CU, determining whether the intra prediction mode is a conventional intra prediction mode close to a horizontal mode; and
in response to the intra prediction mode being a conventional intra prediction mode close to the horizontal mode, applying the SBT intra mode for the current CU.

38. The method according to clause 36, wherein the decoding further comprises:
determining whether an area of the current CU is greater than a threshold;
in response to the area being greater than the threshold, determining whether the intra prediction mode is a DC mode; and
in response to the intra prediction mode being the DC mode, applying the SBT intra mode for the current CU.

39. The method according to clause 36, wherein the decoding further comprises:
determining whether an area of the current CU is greater than a first threshold and less than a second threshold; and
in response to the area of the current CU is greater than the first threshold and less than the second threshold, applying the SBT intra mode for the current CU.

40. The method according to clause 36, wherein the decoding further comprises:
determining whether a width of is equal to a height of the current CU; and
in response to the width of being not equal to the height of the current CU, applying the SBT intra mode for the current CU.

41. The method according to clause 34, wherein the sub-mode is selected from a set of sub-modes.

42. The method according to clause 41, wherein the decoding further comprises:
constructing a candidate list of sub-modes for the current CU.

43. The method according to clause 42, wherein the candidate list for a conventional intra prediction mode is constructed based on histogram of gradients (HoGs).

44. The method according to clause 42, wherein the candidate list is constructed based on a block size of the current CU.

45. The method according to clause 42, wherein the candidate list is constructed based on a block shape of the current CU.

46. The method according to clause 42, wherein the candidate list is constructed based on an intra prediction mode.

47. The method according to clause 46, wherein
in response to the intra prediction mode is a neural network-based intra prediction (NNIP) mode, the candidate list comprises a first group of sub-modes; and
in response to the intra prediction mode is a conventional intra prediction mode, the candidate list comprises a second group of sub-modes.

48. The method according to clause 46, wherein
in response to the intra prediction mode is a non-conventional intra prediction mode, the candidate list is constructed based on a derived conventional intra mode.

49. The method according to clause 41, wherein the sub-modes are divided into three dimensions including a shape of the sub-block, a position of the sub-block, a direction of the sub-block.

50. The method according to clause 49, wherein a position of the sub-mode is implicitly derived; or a position and a direction of the sub-mode is implicitly derived.

51. The method according to clause 50, wherein the implicit derivation is based on information of predicted values of samples within the current CU.

52. The method according to clause 51, wherein the position of the sub-mode is implicitly derived, and determining the sub-mode of the SBT intra mode further comprises:
decoding a syntax indicating a shape of a group of sub-modes;
calculating a horizontal gradient and a vertical gradient of predicted values for each sample in a coded sub-block in each sub-mode of the group of sub-modes; and
selecting a sub-mode that has the maximum sum of gradients of the samples in the coded sub-block from the group of sub-modes to be the determined sub-mode.

53. The method according to clause 51, wherein the position and the direction of the sub-mode are implicitly derived, and determining the sub-mode of the SBT intra mode further comprises:
decoding a syntax indicating both shape and direction for the sub-mode;
calculating a horizontal gradient and a vertical gradient of predicted values for each sample in a coded sub-block; and
selecting a sub-block that has the maximum sum of gradients of the samples in the coded sub-block to be the determined sub-mode.

54. The method according to clause 50, wherein the implicit derivation is based on gradient information of reconstructed values of sample adjacent to the current CU.

55. The method according to clause 50, wherein the implicit derivation is based on template cost.

56. The method according to clause 50, wherein whether to apply the implicit derivation is determined based on the intra prediction mode of the current CU.

57. The method according to clause 35, wherein the transform kernel is determined based on a position of a coded sub-block.

58. The method according to clause 35, wherein the transform kernel is determined based on the intra prediction mode.

59. The method according to clause 34, wherein in response to the flag indicating the SBT intra mode is applied, a low-frequency non-separable transform (LFNST) and a non-separable primary transform (NSPT) are not applied to the current CU.

60. The method according to clause 34, wherein the decoding further comprises:
decoding a second flag indicting whether to apply a low-frequency non-separable transform (LFNST) and to a coded sub-block.

61. The method according to clause 34, wherein the flag indicating whether the SBT intra mode is applied for the current CU is a first flag, and the first flag is decoded before a second flag, wherein the second flag indicates whether there is non-zero residual in a transform unit.

62. The method according to clause 61, wherein the decoding further comprises:
in response to a value the first flag being a first value, skipping decoding the second flag;
inferring a value of the second flag to be the first value for a coded transform unit; and
inferring the value of the second flag to be a second value for a non-coded transform unit.

63. The method according to clause 34, wherein the flag indicating whether the SBT intra mode is applied for the current CU is a first flag, and the first flag is encoded after a second flag, wherein the second flag indicates whether there is non-zero residual in the current CU.

64. The method according to clause 63, wherein the decoding further comprises:
in response to the second flag being a first value, decoding the first flag.

65. The method according to clause 34, wherein the SBT intra mode is applied for at least one of luma component or chroma components based on a partition mode, and the decoding further comprises:
in response to a value the partition mode is a dual tree, the SBT intra mode is applied for luma component; or
in response to a value the partition mode is a single tree, the SBT intra mode is applied for luma component and chroma components.

66. A method for transmitting a bitstream, the method comprising:
receiving a video sequence;
encoding the video sequence by:
   encoding a flag indicating whether a subblock transform (SBT) intra mode is applied for a current coding unit (CU), wherein the current CU is coded in an intra prediction mode;
   in response to the flag indicating the SBT intra mode is applied, determining a sub-mode of the SBT intra mode; and
   encoding residuals of a sub-block based on the sub-mode; and
transmitting a bitstream that is generated based on the encoding.

67. The method according to clause 66, wherein encoding the residuals of a sub-block based on the sub-mode further comprises:
encoding the residuals of sub-blocks with a transform kernel based on the sub-mode, wherein the transform kernel is inferred from the sub-mode.

68. The method according to clause 66, wherein whether to encode the flag is further determined by a block size of the current CU.

69. The method according to clause 68, wherein the encoding further comprises:
determining whether a width is greater than a height of the current CU;
in response to the width being greater than the height of the current CU, determining whether the intra prediction mode is a conventional intra prediction mode close to a horizontal mode; and
in response to the intra prediction mode being a conventional intra prediction mode close to the horizontal mode, applying the SBT intra mode for the current CU.

70. The method according to clause 68, wherein the encoding further comprises:
determining whether an area of the current CU is greater than a threshold;
in response to the area being greater than the threshold, determining whether the intra prediction mode is a DC mode; and
in response to the intra prediction mode being the DC mode, applying the SBT intra mode for the current CU.

71. The method according to clause 68, wherein the encoding further comprises:
determining whether an area of the current CU is greater than a first threshold and less than a second threshold; and
in response to the area of the current CU is greater than the first threshold and less than the second threshold, applying the SBT intra mode for the current CU.

72. The method according to clause 68, wherein the encoding further comprises:
determining whether a width of is equal to a height of the current CU; and
in response to the width of being not equal to the height of the current CU, applying the SBT intra mode for the current CU.

73. The method according to clause 66, wherein the sub-mode is selected from a set of sub-modes.

74. The method according to clause 73, wherein the encoding further comprises: constructing a candidate list of sub-modes for the current CU.

75. The method according to clause 74, wherein the candidate list for a conventional intra prediction mode is constructed based on histogram of gradients (HoGs).

76. The method according to clause 74, wherein the candidate list is constructed based on a block size of the current CU.

77. The method according to clause 74, wherein the candidate list is constructed based on a block shape of the current CU.

78. The method according to clause 74, wherein the candidate list is constructed based on an intra prediction mode.

79. The method according to clause 78, wherein
in response to the intra prediction mode is a neural network-based intra prediction (NNIP) mode, the candidate list comprises a first group of sub-modes; and
in response to the intra prediction mode is a conventional intra prediction mode, the candidate list comprises a second group of sub-modes.

80. The method according to clause 78, wherein
in response to the intra prediction mode is a non-conventional intra prediction mode, the candidate list is constructed based on a derived conventional intra mode.

81. The method according to clause 73, wherein the sub-modes are divided into three dimensions including a shape of the sub-block, a position of the sub-block, a direction of the sub-block.

82. The method according to clause 81, wherein a position of the sub-mode is implicitly derived; or a position and a direction of the sub-mode is implicitly derived.

83. The method according to clause 82, wherein the implicit derivation is based on information of predicted values of samples within the current CU.

84. The method according to clause 83, wherein the position of the sub-mode is implicitly derived, and determining the sub-mode of the SBT intra mode further comprises:
encoding a syntax indicating a shape of a group of sub-modes;
calculating a horizontal gradient and a vertical gradient of predicted values for each sample in a coded sub-block in each sub-mode of the group of sub-modes; and
selecting a sub-mode that has the maximum sum of gradients of the samples in the coded sub-block from the group of sub-modes to be the determined sub-mode.

85. The method according to clause 83, wherein the position and the direction of the sub-mode are implicitly derived, and determining the sub-mode of the SBT intra mode further comprises:
encoding a syntax indicating both shape and direction for the sub-mode;
calculating a horizontal gradient and a vertical gradient of predicted values for each sample in a coded sub-block; and
selecting a sub-block that has the maximum sum of gradients of the samples in the coded sub-block to be the determined sub-mode.

86. The method according to clause 82, wherein the implicit derivation is based on gradient information of reconstructed values of sample adjacent to the current CU.

87. The method according to clause 82, wherein the implicit derivation is based on template cost.

88. The method according to clause 82, wherein whether to apply the implicit derivation is determined based on the intra prediction mode of the current CU.

89. The method according to clause 67, wherein the transform kernel is determined based on a position of a coded sub-block.

90. The method according to clause 67, wherein the transform kernel is determined based on the intra prediction mode.

91. The method according to clause 66, wherein in response to the flag indicating the SBT intra mode is applied, a low-frequency non-separable transform (LFNST) and a non-separable primary transform (NSPT) are not applied to the current CU.

92. The method according to clause 66, wherein the encoding further comprises:
encoding a second flag indicting whether to apply a low-frequency non-separable transform (LFNST) and to a coded sub-block.

93. The method according to clause 66, wherein the flag indicating whether the SBT intra mode is applied for the current CU is a first flag, and the first flag is encoded before a second flag, wherein the second flag indicates whether there is non-zero residual in a transform unit.

94. The method according to clause 93, wherein the encoding further comprises:
in response to a value the first flag being a first value, skipping encoding the second flag;
inferring a value of the second flag to be the first value for a coded transform unit; and
inferring the value of the second flag to be a second value for a non-coded transform unit.

95. The method according to clause 66, wherein the flag indicating whether the SBT intra mode is applied for the current CU is a first flag, and the first flag is encoded after a second flag, wherein the second flag indicates whether there is non-zero residual in the current CU.

96. The method according to clause 95, wherein the encoding further comprises:
in response to the second flag being a first value, encoding the first flag.

97. The method according to clause 66, wherein the SBT intra mode is applied for at least one of luma component or chroma components based on a partition mode, and the encoding further comprises:
in response to a value the partition mode is a dual tree, the SBT intra mode is applied for luma component; or
in response to a value the partition mode is a single tree, the SBT intra mode is applied for luma component and chroma components.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A method for decoding a bitstream, the method comprising:
receiving a bitstream; and
decoding the bitstream to form/generate/output a video sequence, the decoding comprising:
decoding a flag indicating whether a subblock transform (SBT) intra mode is applied for a current coding unit (CU), wherein the current CU is coded in an intra prediction mode;
in response to the flag indicating the SBT intra mode is applied, determining a sub-mode of the SBT intra mode; and
decoding residuals of a sub-block based on the sub-mode.

2. The method according to claim 1, wherein decoding the residuals of a sub-block based on the sub-mode further comprises:
decoding the residuals of sub-blocks with a transform kernel based on the sub-mode, wherein the transform kernel is inferred from the sub-mode.

3. The method according to claim 1, wherein whether to decode the flag is further determined by a block size of the current CU.

4. The method according to claim 1, wherein the sub-mode is selected from a set of sub-modes.

5. The method according to claim 1, wherein in response to the flag indicating the SBT intra mode is applied, a low-frequency non-separable transform (LFNST) and a non-separable primary transform (NSPT) are not applied to the current CU.

6. The method according to claim 1, wherein the flag indicating whether the SBT intra mode is applied for the current CU is a first flag, and the first flag is encoded before a second flag, wherein the second flag indicates whether there is non-zero residual in a transform unit.

7. The method according to claim 1, wherein the SBT intra mode is applied for at least one of luma component or chroma components based on a partition mode, the decoding further comprises:
in response to a value the partition mode is a dual tree, the SBT intra mode is applied for luma component; or
in response to a value the partition mode is a single tree, the SBT intra mode is applied for luma component and chroma components.

8. A method for encoding a video sequence, the method comprising:
receiving a video sequence; and
encoding the video sequence by:
encoding a flag indicating whether a subblock transform (SBT) intra mode is applied for a current coding unit (CU), wherein the current CU is coded in an intra prediction mode;
in response to the flag indicating the SBT intra mode is applied, determining a sub-mode of the SBT intra mode; and
encoding residuals of a sub-block based on the sub-mode.

9. The method according to claim 8, wherein encoding the residuals of a sub-block based on the sub-mode further comprises:
encoding the residuals of sub-blocks with a transform kernel based on the sub-mode, wherein the transform kernel is inferred from the sub-mode.

10. The method according to claim 8, wherein whether to encode the flag is further determined by a block size of the current CU.

11. The method according to claim 8, wherein the sub-mode is selected from a set of sub-modes.

12. The method according to claim 8, wherein in response to the flag indicating the SBT intra mode is applied, a low-frequency non-separable transform (LFNST) and a non-separable primary transform (NSPT) are not applied to the current CU.

13. The method according to claim 8, wherein the flag indicating whether the SBT intra mode is applied for the current CU is a first flag, and the first flag is encoded before a second flag, wherein the second flag indicates whether there is non-zero residual in a transform unit.

14. The method according to claim 8, wherein the SBT intra mode is applied for at least one of luma component or chroma components based on a partition mode, the encoding further comprises:
in response to a value the partition mode is a dual tree, the SBT intra mode is applied for luma component; or
in response to a value the partition mode is a single tree, the SBT intra mode is applied for luma component and chroma components.

15. The method according to claim 8, further comprising:
storing a bitstream that is generated based on the encoding.

16. A method for transmitting a bitstream, the method comprising:
receiving a video sequence;
encoding the video sequence by:
encoding a flag indicating whether a subblock transform (SBT) intra mode is applied for a current coding unit (CU), wherein the current CU is coded in an intra prediction mode;
in response to the flag indicating the SBT intra mode is applied, determining a sub-mode of the SBT intra mode; and
encoding residuals of a sub-block based on the sub-mode; and
transmitting a bitstream that is generated based on the encoding.

17. The method according to claim 16, wherein encoding the residuals of a sub-block based on the sub-mode further comprises:
encoding the residuals of sub-blocks with a transform kernel based on the sub-mode, wherein the transform kernel is inferred from the sub-mode.

18. The method according to claim 16, wherein whether to encode the flag is further determined by a block size of the current CU.

19. The method according to claim 16, wherein the sub-mode is selected from a set of sub-modes.

20. The method according to claim 16, wherein in response to the flag indicating the SBT intra mode is applied, a low-frequency non-separable transform (LFNST) and a non-separable primary transform (NSPT) are not applied to the current CU.
